(19) United States
(12) Patent Application Publication
(10) Pub. No.: US 2006/0059232 A1
(43) Pub. Date: Mar. 16, 2006

(54) Message transmission/reception system and method

(76) Inventor: Masato Yoshikawa, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 10/518,917

(22) PCT Filed: Jun. 11, 2003
(86) PCT No.: PCT/JP03/07396

§ 371 Date: Dec. 23, 2004

(30) Foreign Application Priority Data
Jun. 26, 2002 (JP) 2002-185423

(51) Int. Cl. G06F 15/16

(52) U.S. Cl. 709/206

(57) ABSTRACT

In a mobile terminal (1), upon completion of the preparation of a transmission message in a message preparation unit (13), a position information appending unit (12) uses a position-acquisition unit (11) to begin acquisition of its position and thus acquires information of the current position of the mobile terminal (1). The position information appending unit (12) appends the position information that has been acquired by the position-acquisition unit (11) to the message and transmits the message from a message transmission unit (14) to a position-designated message server (2). The position-designated message server (2) transmits the message to the (destination) mobile terminal (3) when the position information that has been appended to the message that was transmitted from the mobile terminal (1) matches with position information that has been sent in from the mobile terminal (3).

### TECHNICAL FIELD

The present invention relates to a message transmitting and receiving system, terminal device, and server, and further, to a message transmitting and receiving method and program that are used in this system and these devices, and more particularly to a system for transmitting a message to which position information has been appended and receiving the message at a position-designated destination.

### BACKGROUND ART

Examples of this type of message receiving device from the prior art include, for example, devices for receiving electronic mail. In such cases, “message” refers to data that the user of a message transmitting device transmits to the user of a message receiving device, and in the case of an electronic mail system, refers to electronic mail that is transmitted.

An example of the configuration of a message transmitting and receiving system such as described above is shown in FIG. 1. In FIG. 1, this message transmitting and receiving system is made up from: message transmitter 10, message receiver 9, and network 300 that connects message transmitter 10 and message receiver 9. In some cases, the functions of both message transmitter 10 and message receiver 9 are included in a single device.

Message transmitter 10 transmits messages by way of network 300, and message receiver 9 receives messages that have been sent in by way of network 300 and provides the received messages to a user. Message receiver 9 is made up from: message reception unit 91 for receiving messages from message transmitter 10 by way of network 300; and message provision unit 92 together with an interface for providing messages that have been received by message reception unit 91 to a user. The user of message receiver 9 is thus able to receive and refer to messages that another user has created and transmitted using message transmitter 10.

In addition, an example of a method for transmitting this type of position-designated messages is disclosed in, for example, Japanese Patent Laid-Open Publication No. 2001-268620. In this method of transmitting position-designated messages, a server, when acquiring the current position of a terminal device, sends a request for acquisition to the terminal device, and the terminal device, in response to the request for acquisition from the server, acquires position information from a navigation device, inserts the position information in electronic mail, and transmits to the server, whereby the function for transmitting a position-designated message is realized.

In the above-described message transmitting and receiving system of the prior art, when a message is received at message receiver 9, this message is immediately provided to the user by message provision unit 92. As a result, even when a message is transmitted having content that is valid only when the recipient is at a location specified by the sender of the message, the message is provided regardless of whether the recipient is at the specific location.

In order to transmit a message having content that is valid only when at a specific location in the message transmitting and receiving system of the prior art, the sender must check the current position of the recipient and then transmit the message upon confirming that the recipient is at the specified location. However, it cannot be assumed that the sender can always know the current position of a recipient, and when the current position of the recipient is not known, infallibly sending messages that are valid only when the recipient is at a specific location becomes problematic.

In the system for receiving position-designated messages in the above-described prior art, moreover, there is the problem that, when a message is to be received in which the reception position has been designated, the message cannot be transmitted from the user of a mobile terminal. Still further, although the method of the prior art for transmitting position-designated messages allows one's current position to be acquired, appended to a message, and then transmitted so as to report one's own position, this process only notifies the server of the current position of one's own terminal and does not allow designation of the position at which the message is to be received.

### DISCLOSURE OF THE INVENTION

It is an object of the present invention to provide a message transmitting and receiving system, a terminal device, a server, and a message transmitting and receiving method and program that are used in the system, device, and server that, when a message is to be received in which the reception position is designated, allows transmission of the message from devices that include the receiving terminal, and allows designation of the position of receiving the message, and that, as a result, can solve the above-described problems of the prior art.

The message transmitting and receiving system according to the present invention is a message transmitting and receiving system for delivering a message that has been transmitted from a terminal device that is a transmission origin to a terminal device that is a transmission destination, the system being provided with:
a terminal device that is the transmission origin that includes: means for receiving as input the destination of a message and the position at which the message is to be received, and appending means for appending to the message position information that indicates the position that has been received as input;
a server device that includes: message storage means for, upon receiving a message that has been transmitted from a terminal device that is a transmission origin, storing the message that has been received; position request means for extracting the destination address and position information from a message that has been stored in the message storage means and submitting a position request to the terminal device that is the transmission destination that is indicated by the destination address; and message management means for transmitting the message to the terminal device that is the transmission destination when position information that has been appended to a message matches with position information from the terminal device that is the transmission destination that has been transmitted in response to the position request; and
a terminal device that is the transmission destination that includes: a first position-acquisition means for receiving a position request from the server and acquiring position; and a position information transmission means for transmitting position information that has been acquired by the first position-acquisition means to the server device.

According to the message transmitting and receiving system of the present invention, when transmitting a message at the terminal device of the transmission origin that possesses a position-acquisition means, the destination address of the message and position information that indicates the position at which the message should be received are appended. In the server device, the position information and destination address that are contained in the message are extracted when this message is received, a request is submitted to acquire the position of the mobile terminal of the destination address, and the message is transmitted after confirming that the mobile terminal that is the transmission destination is at the designated position. Accordingly, the terminal device that is the transmission origin is able to designate the position at which the terminal device that is the transmission destination is to receive the message.

In addition, the terminal device that is the transmission origin may further include a second position-acquisition means for acquiring its current position information, and the appending means may append position information that has been acquired by the second position-acquisition means to the message as position information of the position at which the message should be received.

In the present invention, position is acquired at the time of transmitting a message at that location and this position information is automatically appended to the message that is transmitted, and as a result, the position at which the message is received can be set to the position at which the message is transmitted.

In addition, another message transmitting and receiving system according to the present invention is a message transmitting and receiving system for delivering a message that is transmitted from a terminal device that is the transmission origin to a terminal device that is the transmission destination; the system being provided with:
a terminal device that is the transmission origin that includes: first position-acquisition means for accepting a position request from the server device and then acquiring position, and position information transmission means for transmitting the position information that has been acquired by the first position-acquisition means to the server device;
a server device including: message storage means for storing messages; position request means for, upon receiving a message that has been transmitted from a transmission origin terminal device, submitting a request for position to the transmission origin terminal device of the message that has been received, and further, for extracting the destination address and position information from a message that has been stored in the message storage means and submitting a position request to the transmission destination terminal device that is the destination address; appending means for appending to the message the position information of the transmission origin terminal device that has been transmitted in response to the position request to the transmission origin terminal device as position information of the position at which the message is to be received and storing the message in the message storage means; and message management means for transmitting the message to the transmission destination terminal device when position information that has been appended to the message matches with position information of the transmission destination terminal device that has been transmitted in response to the position request to the transmission destination terminal device; and
a transmission destination terminal device including: second position-acquisition means for accepting a position request from the server device and acquiring position; and a position information transmission means for transmitting the position information that has been acquired by the second position-acquisition means to the server device.

According to the present invention, a server device that has received a message submits a request to obtain the position of the terminal device that is the transmission origin and appends this position information to the message, and as a result, when the position at which the message is to be received is designated to the current position, settings can be realized without appending the position information to the message and transmitting.

### BRIEF DESCRIPTION OF THE DRAWINGS

FIG. 1 is a block diagram showing the configuration of the message transmitting and receiving system according to the prior art.

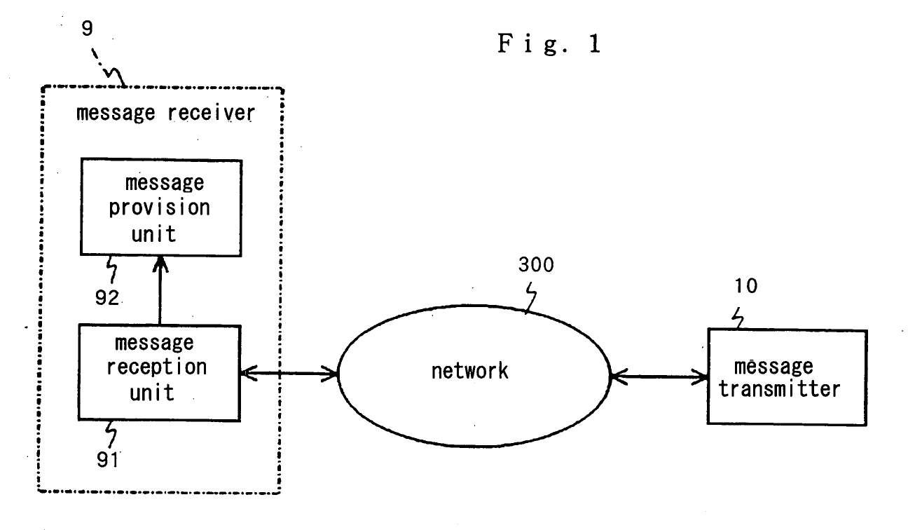

FIG. 2 is a block diagram showing the configuration of the message transmitting and receiving system according to the first embodiment of the present invention.

FIG. 3 is a block diagram showing a specific example of the system configuration of message transmitting and receiving system according to the first embodiment of the present invention.

FIG. 4 shows an example of a position-designated message according to the first embodiment of the present invention.

FIG. 5 is a flow chart showing the procedure for transmitting a position-designated message according to the first embodiment of the present invention.

FIG. 6 shows the procedure for appending position information according to the first embodiment of the present invention.

FIG. 7(a) shows an example of the message management table that is arranged inside the message storage unit of FIG. 2; FIG. 7(b) shows another example of the message management table that is arranged inside the message storage unit of FIG. 2; and FIG. 7(c) shows an example of a message file.

FIG. 8 is a flow chart showing the operations of the position-designated message server according to the first embodiment of the present invention.

FIG. 9 is a block diagram showing the configuration of the message transmitting and receiving system according to the second embodiment of the present invention.

FIG. 10 is a block diagram showing a specific example of the system configuration of the message transmitting and receiving system according to the second embodiment of the present invention.

FIG. 11 is a flow chart showing the procedure of transmitting a position-designated message according to the second embodiment of the present invention.

FIG. 12 is a block diagram showing the configuration of the message transmitting and receiving system according to the third embodiment of the present invention.

FIG. 13 is a block diagram showing a specific example of the system configuration of the message transmitting and receiving system according to the third embodiment of the present invention.

FIG. 14 is a flow chart showing the procedure of transmitting a position-designated message according to the third embodiment of the present invention.

FIG. 15 is a flow chart showing the operations of the position-designated message server according to the third embodiment of the present invention.

FIG. 16 is a block diagram showing the configuration of the message transmitting and receiving system according to the fourth embodiment of the present invention.

FIG. 17(a) shows an example of a message distribution list according to the fourth embodiment of the present invention; and FIG. 17(b) shows an example of the message management table according to the fourth embodiment of the present invention.

FIG. 18 is a flow chart showing the procedure for registering a message distribution list according to the fourth embodiment of the present invention.

FIG. 19 is a flow chart showing the procedure for transmitting a position-designated message according to the fourth embodiment of the present invention.

FIG. 20 is a flow chart showing the operations of the position-designated message server according to the fourth embodiment of the present invention.

FIG. 21 is a block diagram showing the configuration of the message transmitting and receiving system according to the fifth embodiment of the present invention.

FIG. 22 is a flow chart showing the procedure of transmitting a position-designated message according to the fifth embodiment of the present invention.

FIG. 23 is a flow chart showing the operations of the position-designated message server according to the fifth embodiment of the present invention.

FIG. 24 is a block diagram showing the configuration of the message transmitting and receiving system according to the sixth embodiment of the present invention.

FIG. 25 is a flow chart showing the operations of the position-designated message server according to the sixth embodiment of the present invention.

### BEST MODE FOR CARRYING OUT THE INVENTION

Explanation next regards embodiments of the present invention with reference to the accompanying drawings.

### First Embodiment

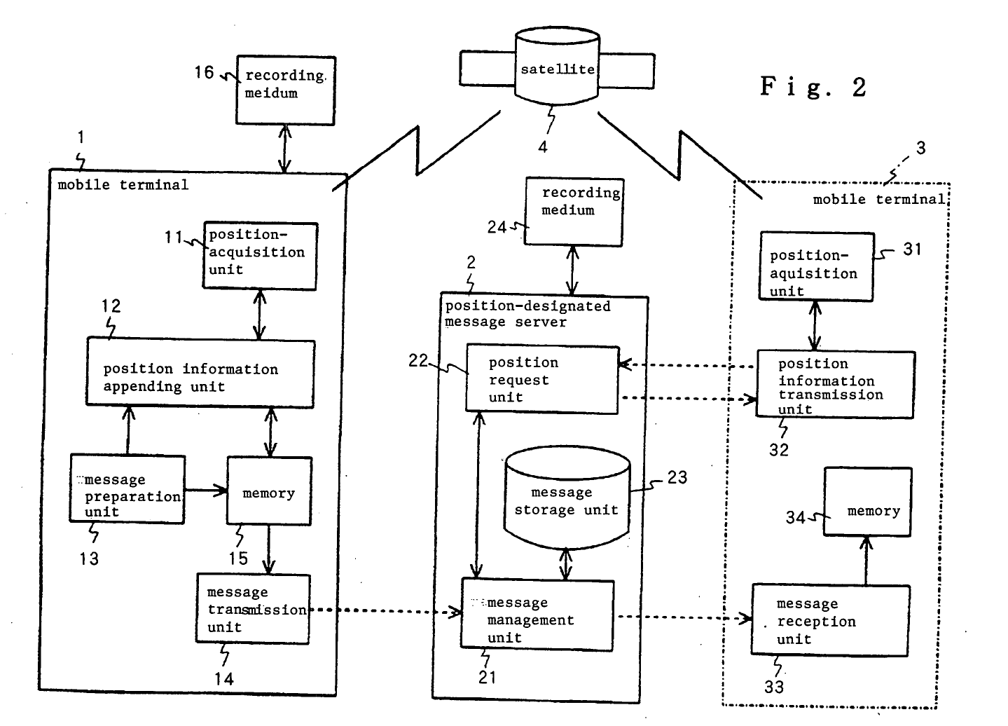

FIG. 2 is a block diagram showing the configuration of the message transmitting and receiving system according to the first embodiment of the present invention. In FIG. 2, the message transmitting and receiving system according to the first embodiment of the present invention is a system for transmitting and receiving messages in which the position of the transmission destination has been designated.

The message transmitting and receiving system according to the first embodiment of the present invention is configured by connecting, by means of a radio communication network, mobile terminal 1, mobile terminal 3, and position-designated message server 2 that performs processing for transmitting and receiving messages between mobile terminal 1 and mobile terminal 3.

Mobile terminal 1 is made up of: message preparation unit 13 for preparing a message in the terminal; position information appending unit 12 that includes a function of appending the current position information to a message that has been prepared, a function for checking whether other position information has been appended, and a function for appending position information according to a choice; position-acquisition unit 11 for receiving a request to acquire the current position from position information appending unit 12; memory 15 for storing messages that have been prepared in message preparation unit 13 and messages to which position information has been appended in position information appending unit 12; message transmission unit 14 for transmitting messages that have been stored in memory 15 to position-designated message server 2; and recording medium 16 for recording a program that operates on a computer (not shown) that realizes the processing of mobile terminal 1.

Position-designated message server 2 is made up of: message management unit 21, position request unit 22, and message storage unit 23; and further, is connected to recording medium 24.

Message management unit 21 is equipped with a function for receiving messages that have been transmitted from mobile terminal 1 and for extracting destinations from messages and a function for transmitting messages to mobile terminal 3. Position request unit 22 submits position requests to mobile terminal 3, which is the transmission destination of messages. Message storage unit 23 stores messages that have been transmitted from mobile terminal 1 until mobile terminal 3, which is the transmission destination of the messages, has moved to the designated position.

Recording medium 24 records programs that operate on a computer (not shown) that realizes the processes of position-designated message server 2. Mobile terminal 3 is made up from: position-acquisition unit 31, position information transmission unit 32, message reception unit 33, and memory 34.

Position-acquisition unit 31 receives requests for the current position information from position-designated message server 2 and acquires position. Position information transmission unit 32 transmits position information from position-acquisition unit 31 to position-designated message server 2. Message reception unit 33 receives messages that are sent in from position-designated message server 2. Memory 34 holds messages that have been received at message reception unit 33.

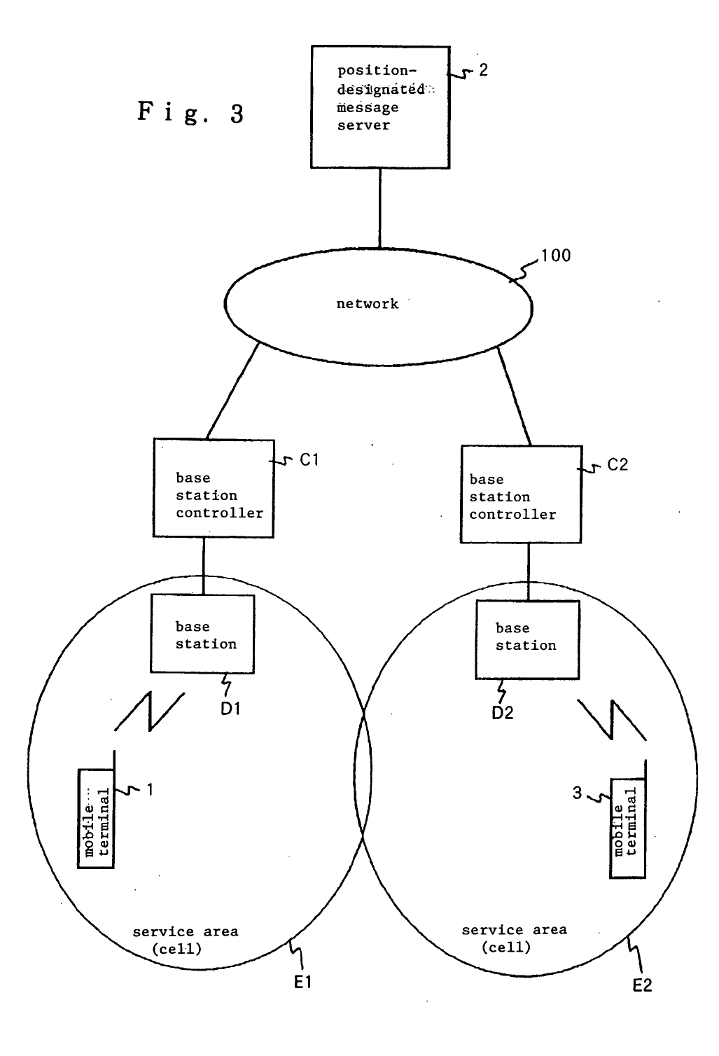

FIG. 3 is a block diagram showing a specific example of the system configuration of a message transmitting and receiving system according to the first embodiment of the present invention. In FIG. 3, mobile terminal 1 and mobile terminal 3 are in a state allowing communication within service areas (cells) E1 and E2 that are managed by base stations D1 and D2, respectively, and position-designated message server 2 can connect to mobile terminal 1 and mobile terminal 3 by way of network 100, base station controllers C1 and C2, and base stations D1 and D2. Mobile terminal 1 and mobile terminal 3 are able to connect to network 100 by way of base stations D1 and D2, respectively; but mobile terminal 1 and mobile terminal 3 may also connect to network 100 by way of relay devices realized by radio or by relay devices realized by cables.

In this case, base station D1 sends position registration requests from mobile terminal 1 that is within its own service area E1 to base station controller C1 that controls base station D1; and base station D2 sends position registration requests from mobile terminal 3 that is within its own service area E2 to base station controller C2 that controls base station D2. Base station controllers C1 and C2 manage the position information of mobile terminal 1 and mobile terminal 3, respectively, based on the position registration requests, and based on this position information, transfer calls from other base stations (not shown) or calls from a public network (not shown) to base stations D1 and D2 where the destination mobile terminal 1 and mobile terminal 3 are located.

In other words, base station controllers C1 and C2 are each able to always know the position of each of mobile terminal 1 and mobile terminal 3 (service areas E1 and E2 of each of base stations D1 and D2 in which mobile terminal 1 and mobile terminal 3 are located).

Referring to FIG. 2 and FIG. 3, explanation next regards the operation of the message transmitting and receiving system according to the first embodiment of the present invention. Mobile terminal 1 prepares a message for transmission in message preparation unit 13. The message that is prepared at this time may include e-mail that is prepared on, for example, a typical portable telephone, an Instant Message (IM), or a short message, but as long as the message can be transmitted as a message for communication, no particular constraint is imposed on its form.

When the preparation of a message on mobile terminal 1 has been completed, position information appending unit 12 begins position acquisition using position-acquisition unit 11 and thus acquires information on the current position of mobile terminal 1. Position-acquisition unit 11 may be a GPS (Global Positioning System) positioning method that acquires position information using satellite 4, or a Cell ID method that uses the base station, but no limitation is placed on the method as long as the current position of mobile terminal 1 can be acquired.

Position information appending unit 12 appends position information that is acquired by position-acquisition unit 11 or position information that is received as input from an input device that is not shown to the message that has been prepared in message preparation unit 13. The message to which this position information has been appended is transmitted to position-designated message server 2 by message transmission unit 14 of mobile terminal 1.

Upon receiving a message to which position information has been appended from mobile terminal 1, message management unit 21 of position-designated message server 2 extracts destination address and position information from the message and then both transfers this information to position request unit 22 and stores the message in message storage unit 23 together with the position information.

Position request unit 22 submits a request for the current position to mobile terminal 3, which is designated by the destination address of the message. The request for current position submitted by position request unit 22 is carried out when a predetermined prescribed time interval has elapsed from the reception of a message, or, if the position information of the message indicates a point within the service area E2 of base station D2, when it has been confirmed as the result of an inquiry to base station controller C2 that mobile terminal 3 is located within the service area E2 of base station D2.

The present embodiment can also be applied in a variety of cases other than those described above. For example, the request for the current position may be carried out at a predetermined time, may be carried out when mobile terminal 3 departs from a particular designated area (for example, service areas E1 and E2 of base stations D1 and D2, respectively), or may be carried out a prescribed time interval after mobile terminal 3 has suffered a power cutoff or has departed from a particular range.

Position information transmission unit 32 of mobile terminal 3, upon receiving a request from position-designated message server 2, begins acquisition of position by means of position-acquisition unit 31, and upon acquiring position information in position-acquisition unit 31, transmits this position information to position-designated message server 2. Subsequently, position-designated message server 2 periodically submits requests for current position to mobile terminal 3.

When the position information that is sent in from mobile terminal 3 matches with position information that has been appended to a message that has been transmitted from mobile terminal 1 and it is thus confirmed that mobile terminal 3 has arrived at the designated position, message management unit 21 of position-designated message server 2 immediately transmits the message that is in message storage unit 23 to mobile terminal 3. Mobile terminal 3 acquires the message from position-designated message server 2 by means of message reception unit 33. In this way, when mobile terminal 3 arrives at the designated position, the message to which position information was added at the time of transmission at mobile terminal 1 is transmitted from position-designated message server 2 to mobile terminal 3 by way of network 100, base station controller C2, and base station D2, whereby the position of receiving the message can be designated.

However, it can also be supposed that the recipient of the message does not proceed to the designated location, and such a case raises the problem that the message remains stored in message storage unit 23 of position-designated message server 2, thereby imposing on the capacity of message storage unit 23. Explanation therefore next regards the operation of position-designated message server 2 in a case in which the recipient of a message does not arrive at the designated position and the message is therefore not transmitted.

After receiving a message to which position information has been appended, position-designated message server 2 periodically requests the position in which mobile terminal 3, which is designated as the transmission destination, is located until mobile terminal 3 arrives at the designated position. The time limit for these requests for the location position can be set by the sender of the message or by the administrator of position-designated message server 2.

If the message recipient does not arrive at the designated position within this time limit, the message is processed by means that is determined by the administrator of position-designated message server 2 or means that is determined by the sender.

Methods that can be considered as this message processing method include, for example: a method in which, when the time limit has elapsed, the message is returned to the sender and an indication that the recipient was not able to receive is transmitted in the message; a method in which the message is transmitted to the recipient and an indication that this message was designated for reception at a particular designated position is transmitted in the message; and a method in which the message is discarded.

Alternatively, other methods that can be considered as the above-described message processing method include a method in which, when transmitting the message, the sender selects among methods by which, when the recipient does not arrive within a particular time interval, the message is discarded and a message is transmitted to the sender indicating that transmission was not possible; a method in which the message is transmitted to the recipient and an indication is sent in the message that a position had been designated; and a method in which the message is discarded.

Adoption of any one or a combination of the above-described methods enables circumvention of the problem that a message continues to be held for an extended time interval in message storage unit 23 of position-designated message server 2.

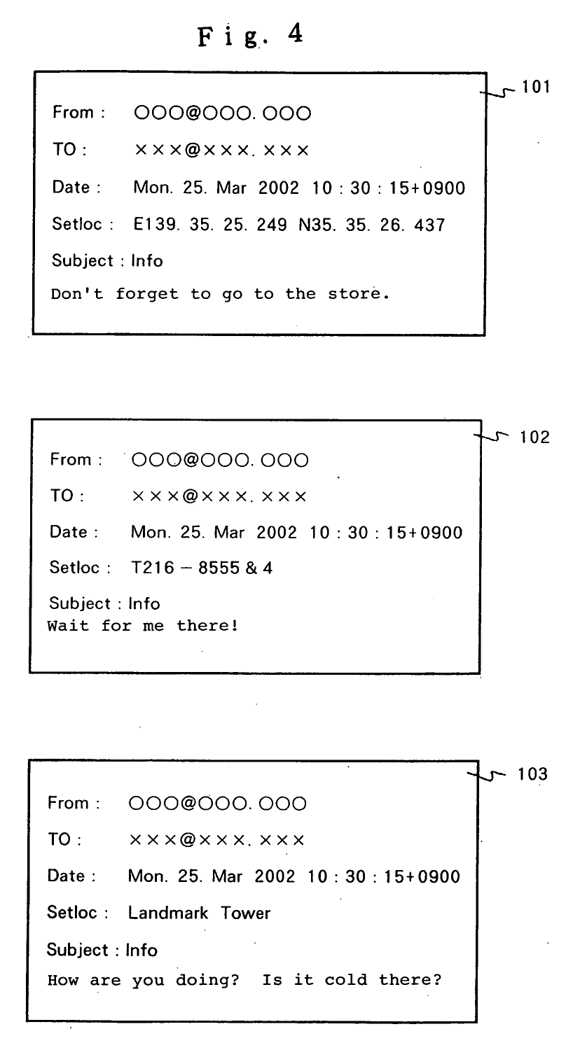

FIG. 4 shows an example of a position-designated message according to the first embodiment of the present invention. In FIG. 4, position information appended message 101 is composed of: transmission origin address “From:OOO@OOO.OOO”; destination address “To: XXX@XXX.XXX”; date “Date: Mon. 25. Mar 2002 10:30:15 +0900”; position information “Set loc: E139.35.25.249 N35.35.26.437”; title “Subject: Info”; and content “Don't forget to go to the store.”

Position information appended message 102 is composed of: “transmission origin address “From: OOO@OOO.OOO”; destination address “To: XXX@XXX.XXX”; date “Date: Mon. 25. Mar 2002 10:30:15 +0900”; position information (an address indicated by a postal number) “Set loc: T216-8555&4”; title “Subject: Info”; and content “Wait for me there!” Position information appended message 103 is composed of: transmission origin address “From: OOO@OOO.OOO”; Destination address “To: XXX@XXX.XXX”; date “Date: Mon. 25. Mar 2002 10:30:15 +0900”; position information “Set loc: Landmark Tower”; title “Subject: Info”; and content “How are you doing? Is it cold there?”

As described above, position information appended message 101 is an example in which latitude and longitude information that has been obtained by GPS is recorded as position information; position information appended message 102 is an example in which an address (such as a postal number) is recorded as position information; and position information appended message 103 is an example in which a landmark such as a building for which the longitude and latitude are known beforehand is recorded as the position information. When position information is compared, the address and landmark that are the position information of the above-described position information appended message 102 and position information appended message 103 are used by first converting to latitude and longitude information.

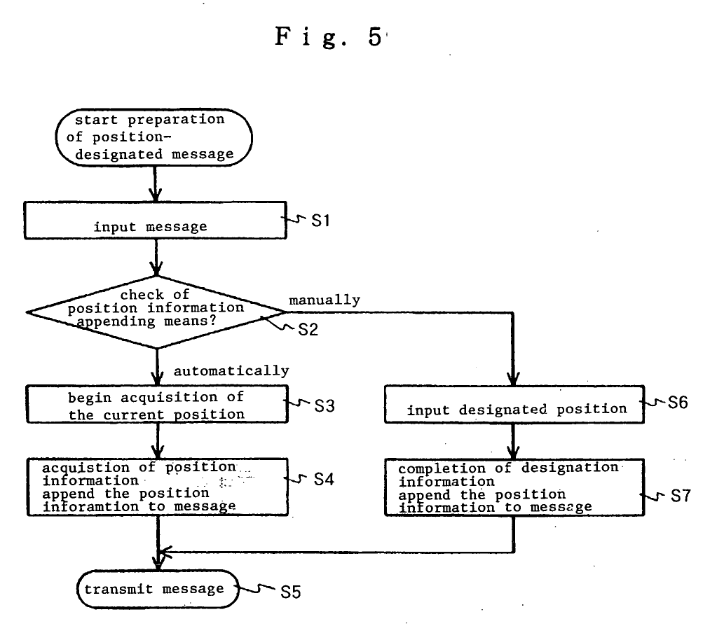

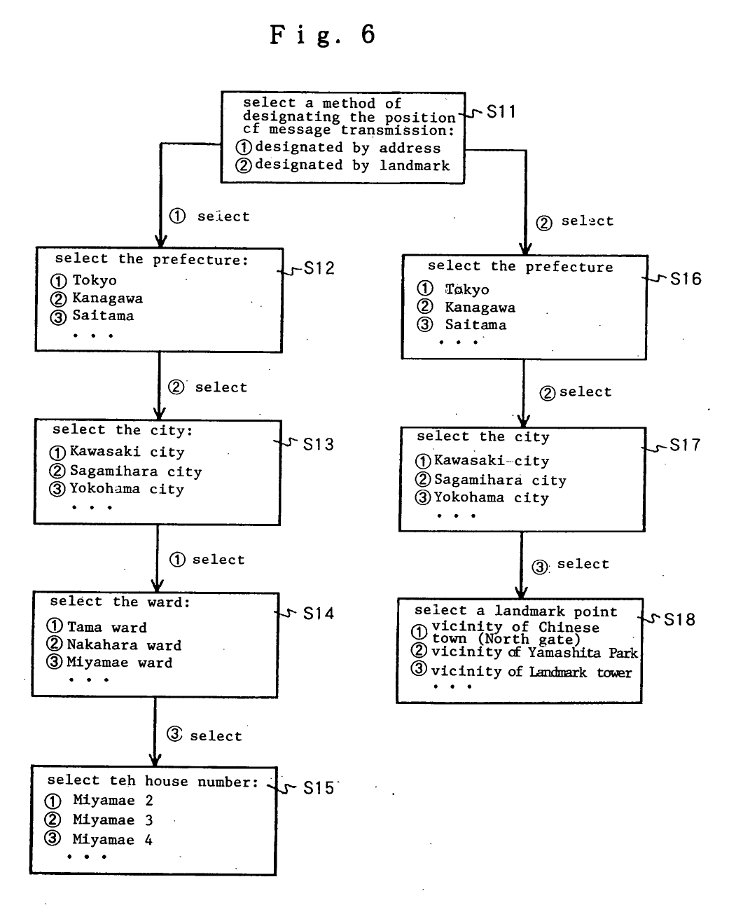

FIG. 5 is a flow chart showing the procedure for transmitting a position-designated message according to the first embodiment of the present invention, and FIG. 6 shows the procedure for appending position information according to the first embodiment of the present invention. Referring to FIGS. 2-6, explanation next regards the operations for preparing and transmitting a position-designated message. In addition, the processes shown in FIGS. 5 and 6 are realized by the execution of the program of recording medium 16 by the computer of mobile terminal 1.

Mobile terminal 1, which has the function of acquiring position, begins the preparation of a position message by means of message preparation unit 13, completes input of the message, and stores the message in memory 15 (step S1 in FIG. 5), whereupon the mobile terminal 1 performs a check of the position information appending means with the user, prompting the user to select whether the current position is to be appended to the message automatically or position information is to be appended to the message manually (step S2 in FIG. 5).

If position information is to be appended automatically, position information appending unit 12 requests position-acquisition unit 11 to begin the acquisition of the current position (step S3 in FIG. 5). When position-acquisition unit 11 completes acquisition of the position, position information appending unit 12 obtains the position information from position-acquisition unit 11 and appends this information to the message that is stored in memory 15 (step S4 in FIG. 5). The message to which the position information has been appended (See 101 in FIG. 4) is transmitted by means of message transmission unit 14 and thus sent to position-designated message server 2 (step S5 in FIG. 5).

Alternatively, if the transmission position information is to be designated manually, position information appending unit 12 begins the operation of input of the designated position to obtain the position information by designation through manual input from the user (step S6 in FIG. 5).

Transmission position designation is set by a hierarchical display that closes in from general content to detailed content. As shown in FIG. 6, the method employed may be a method of closing in from by address and then converting to a postal number when appending to the message, by closing in by landmark, or a combination of these methods.

For example, a combination of these methods is used in the closing-in method shown in FIG. 6 in which the user is first prompted to select between designation by address and designation by landmark as the method of designating the position of message transmission (step S11 in FIG. 6).

If designation by address is selected, the user is successively prompted to select the prefecture (step S12 in FIG. 6), to select the city (step S13 in FIG. 6), to select the ward (step S14 in FIG. 6), and to select the house number (step S15 in FIG. 6), these selections being converted to postal number when appended to the message.

In contrast, when designation by landmark is selected, the user is successively prompted to select the prefecture (step S16 in FIG. 6), to select the city (step S17 in FIG. 6), and then to select a landmark point (step S18 is FIG. 6).

When the transmission position has been determined by closing in as described in the foregoing explanation, position information appending unit 12 appends the position information to the message (102 in FIG. 4 when designated by address, and 103 in FIG. 4 when designated by landmark) (step S7 in FIG. 5), and the message is transmitted to position-designated message server 2 by message transmission unit 14 (step S5 in FIG. 5).

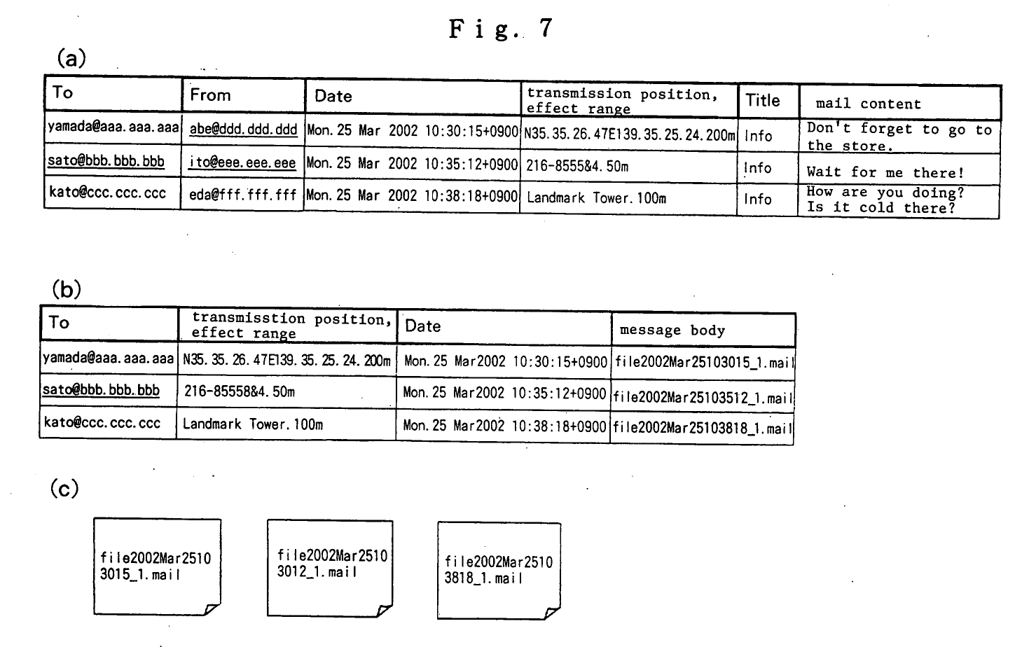

FIG. 7(a) shows an example of a message management table that is arranged in message storage unit 23 of FIG. 2; FIG. 7(b) shows another example of a message management table that is arranged in message storage unit 23 of FIG. 2; and FIG. 7(c) shows an example of a message file.

In FIG. 7(a), the message management table is composed of: the destination address (To) “yamada@aaa.aaa.aaa”, “sato@bbb.bbb.bbb”, and kato@ccc.ccc.ccc”; the transmission origin address (From) “abe@ddd.ddd.ddd”, “ito@eee.eee.eee”, and “eda@fff.fff.fff”; the date (Date) “Mon.25.Mar 2002 10:30:15 +0900”, “Mon.25.Mar 2002 10:35:12 +0900”, and “Mon.25.Mar 2002 10:38:18 +0900”; the transmission position and effective range “N35.35.26.47 E139.35.25.24, 200m”, “T216-8555&4, 50m”, and “Landmark Tower, 100m”; the title (Title) “Info”; and the mail content “Don't forget to go to the store,” “Wait for me there!”, and “How are you doing? Is it cold there?” In this case, the effective range designates the range from a designated position, and in the above-described case, indicates the distances “200 meters,” “50 meters,” and “100 meters. When the effective range has been designated, a message is transmitted from the position-designated message server when the mobile terminal (B) that is the destination of a message enters the effective range. Effective range can be designated or not, and its use should be determined according to the situation.

In the message management table shown in FIG. 7(b), the message files are held separately in the form that is shown in FIG. 7(c). In other words, the message management table is composed of: destination address (To) “yamada@aaa.aaa.aaa”, “sato@bbb.bbb.bbb”, and “kato@ccc.ccc.ccc”; the transmission position and effective range “N35.35.26.47 E139.35.25.24, 200m”, “T216-8555&4, 50m” and “Landmark Tower, 100m”; the date (Date) “Mon.25.Mar 2002 10:30:15 +0900”, “Mon.25.Mar 2002 10:35:12 +0900”, and “Mon.25.Mar 2002 10:38:18 +0900”; and the message body. The file names “file2002Mar25103015_{—}1.mail”, “file2002Mar25103512_{—}1.mail”, and “file2002Mar25103818_{—}1.mail” that are shown in FIG. 7(c) are stored in the message body.

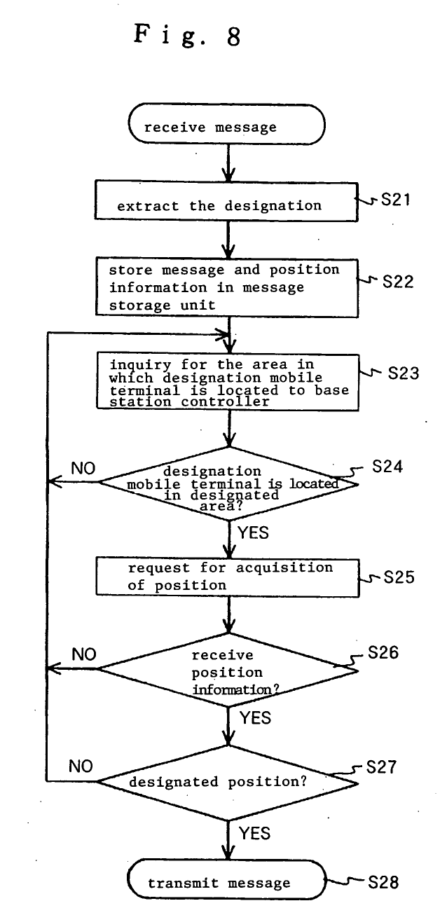

FIG. 8 is a flow chart showing the operation of position-designated message server 2 according to the first embodiment of the present invention. Explanation next regards the operation of position-designated message server 2 with reference to FIGS. 2, 3, and 8. The processes shown in FIG. 8 are realized by execution of the programs of recording medium 24 by the computer of position-designated message server 2.

Upon receiving a message to which position information has been appended, message management unit 21 of position-designated message server 2 extracts the destination address and position information from this message, transfers this information to position request unit 22 (step S21 of FIG. 8), and stores this message in message storage unit 23 together with the position information (step S22 in FIG. 8).

Position request unit 22 submits inquiries to base station controllers C1 and C2 to find the area in which destination mobile terminal 3 is located (step S23 in FIG. 8). Then, upon notification from base station controller C2 that destination mobile terminal 3 is located in service area E2 of base station D2, which is the service area that includes the above-described position information (step S24 in FIG. 8), position request unit 22 submits a request to destination mobile terminal 3 for its current position (step S25 in FIG. 8). Alternatively, the request for current position to mobile terminal 3 may be transmitted without submitting inquiries to base station controllers C1 and C2 when a predetermined prescribed time interval has elapsed after the reception of a message.

Upon receiving the request from position-designated message server 2, position information transmission unit 32 of mobile terminal 3 begins the acquisition of position by means of position-acquisition unit 31, and when the position information has been obtained in position-acquisition unit 31, transmits this position information to position-designated message server 2. Subsequently, requests for the current position to mobile terminal 3 are submitted periodically from position-designated message server 2 (steps S23-S27 in FIG. 8).

When message management unit 21 of position-designated message server 2 has confirmed that the position information that is sent from destination mobile terminal 3 matches with the position information that was appended to the message that was transmitted from mobile terminal 1 and that destination mobile terminal 3 has arrived at the designated position (steps S26 and 27 in FIG. 8), message management unit 21 immediately transmits the message in message storage unit 23 to mobile terminal 3 (step S28 of FIG. 8). Mobile terminal 3 obtains the message from position-designated message server 2 by means of message reception unit 33, stores the message in memory 34, and displays the message on a display unit (not shown).

In the present embodiment, mobile terminal 1 that is the transmission origin is able to acquire its position at the time of transmitting a message and automatically append the position information to the message that is transmitted, whereby the position at which the message is received can be set to the position at which the message was transmitted.

In the present embodiment, moreover, mobile terminal 1 that is the transmission origin is able to designate the position at which a message is to be received and can append the position of the transmission destination at the time of transmitting the message, whereby the position at which a transmitted message is to be received can be designated.

### Second Embodiment

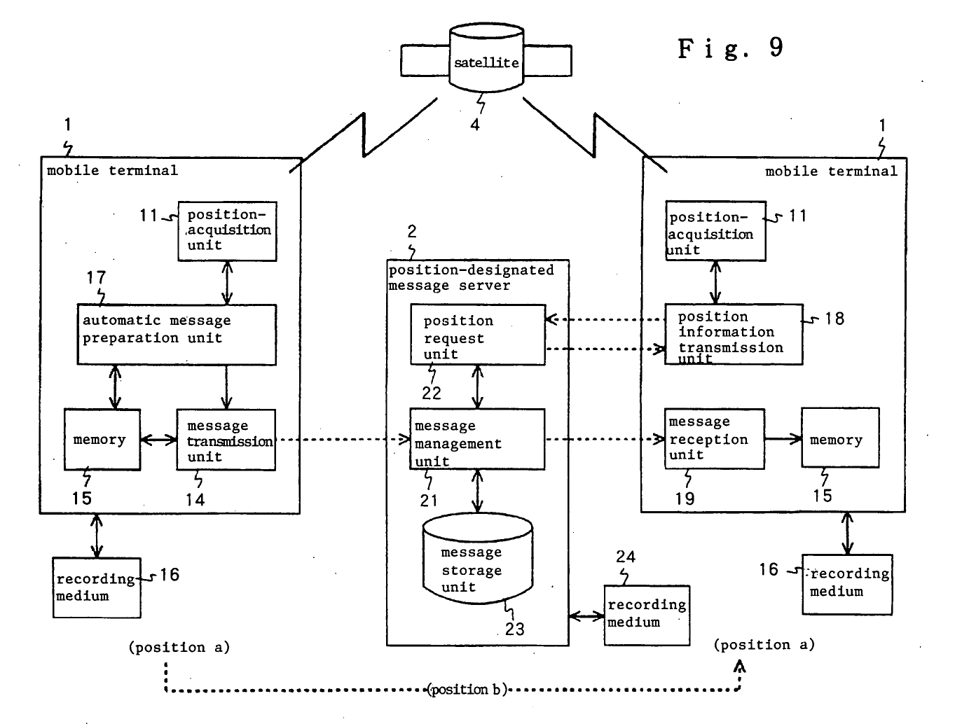

FIG. 9 is a block diagram showing the configuration of the message transmitting and receiving system according to the second embodiment of the present invention. In FIG. 9, the message transmitting and receiving system according to the second embodiment of the present invention can automatically select a message, and further, has the capability of automatically making the destination address a sender. In this case, mobile terminal 1 is made up from: position-acquisition unit 11 for receiving requests for acquisition of the current position; automatic message preparation unit 17 for automatically preparing messages; memory 15 for holding messages that have been prepared at automatic message preparation unit 17 and messages that have been received at message reception unit 19; message transmission unit 14 for transmitting messages that are held in memory 15 to position-designated message server 2; position information transmission unit 18 for transmitting position information from position-acquisition unit 11 to position-designated message server 2; message reception unit 19 for receiving messages that are sent in from position-designated message server 2; and recording medium 16 for recording programs that operate on a computer (not shown) that realizes the processing of mobile terminal 1. The configuration of position-designated message server 2 is similar to position-designated message server 2 in the first embodiment of the present invention that is shown in FIG. 2.

Automatic message preparation unit 17 of mobile terminal 1 displays as a list the content of messages that have been registered beforehand, and moreover, that are to be received subsequently at that terminal, and prompts the user to select the message that he or she wishes to receive. When the user selects from this list a message that the user wishes to receive later, automatic message preparation unit 17 automatically prepares the selected message, automatically sets the destination address to the preparation of the message (the owner of mobile terminal 1), and activates position-acquisition unit 11 to acquire the current position.

Upon acquiring information of the position at which mobile terminal 1 is currently located, position-acquisition unit 11 sends the position information to automatic message preparation unit 17. Automatic message preparation unit 17, upon receiving the position information, automatically appends the position information to the message, and transmits this message from message transmission unit 14 to position-designated message server 2.

The user that owns mobile terminal 1 then leaves position “a” at which the message was transmitted, and moves to position “b,” and then returns to position “a,” where mobile terminal 1 then receives from position-designated message server 2 the previously sent message by means of message reception unit 19. In this case, as in the above-described first embodiment of the present invention, position-designated message server 2 can learn that mobile terminal 1 has returned to position “a” by implementing requests for current position to position information transmission unit 18 of mobile terminal 1 by means of position request unit 22 of position-designated message server 2. In this way, the present embodiment is capable of realizing a message transmission function in a “reminding” service in which messages that are prepared by automatic message preparation unit 17 based on information that has been selected from a list are received after returning to the transmission position.

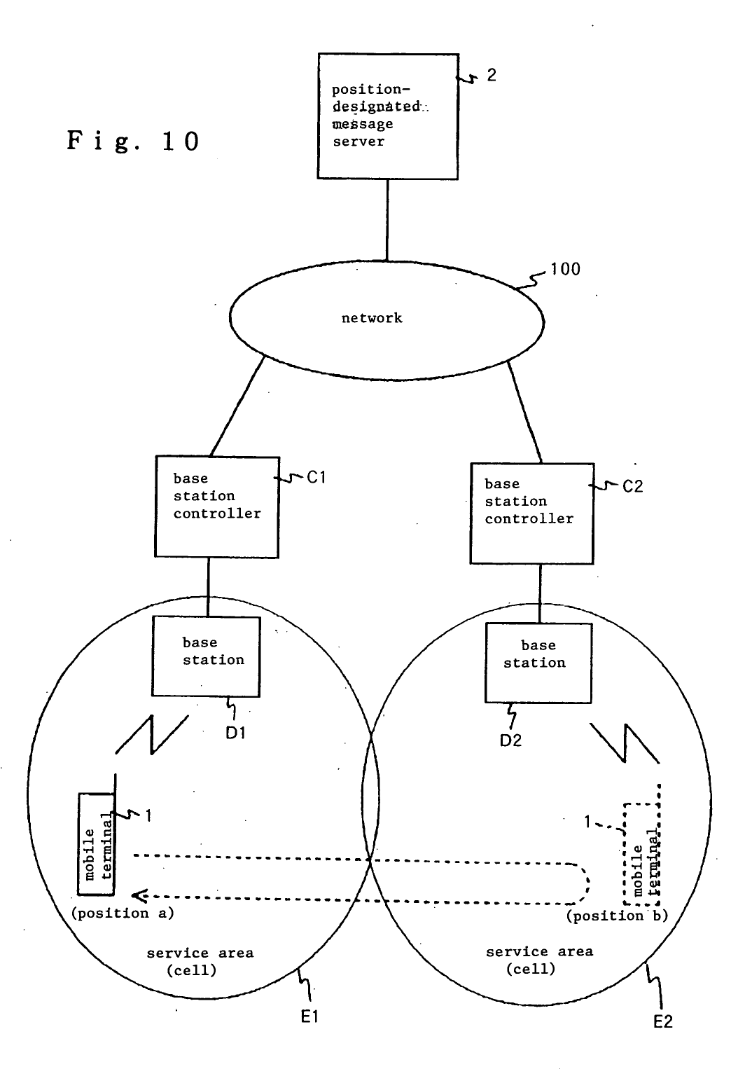

FIG. 10 is a block diagram showing an example of the actual system configuration of the message transmitting and receiving system according to the second embodiment of the present invention. In FIG. 10, a case is shown in which mobile terminal 1 moves from position “a” in service area E1 that is managed by base station D1 to position “b” in service area E2 that is managed by base station D2, and then returns again to position “a” in service area E1.

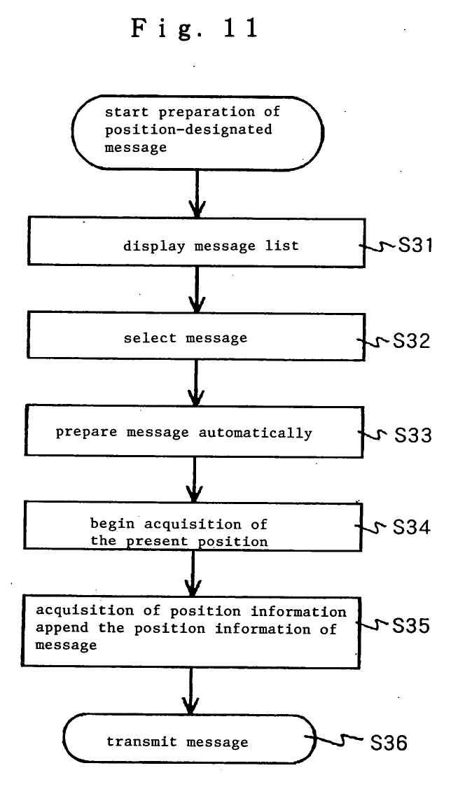

FIG. 11 is a flow chart showing the procedure for transmitting a position-designated message according to the second embodiment of the present invention. Explanation next regards the operations for preparing and transmitting a position-designated message according to the second embodiment of the present invention with reference to these FIGS. 9-11. The processes of FIG. 11 are realized by the execution of the programs of recording medium 16 by the computer of mobile terminal 1.

Automatic message preparation unit 17 of mobile terminal 1 displays a list of the content of messages that have been registered beforehand and that are to be received at a later time by this terminal (step S31 of FIG. 11) and prompts the user to select the message that the user wishes to receive. When the user selects from the list a message that the user wishes to receive at this terminal at a later time (step S32 in FIG. 11), automatic message preparation unit 17 automatically prepares the message (step S33 of FIG. 11), automatically sets the destination address to the creator of the message (the owner of mobile terminal 1), and activates position-acquisition unit 11 to acquire the current position (step S34 of FIG. 11).

Upon acquiring the information of the position at which mobile terminal 1 is currently located, position-acquisition unit 11 sends the position information to automatic message preparation unit 17. Automatic message preparation unit 17, having received the position information, automatically appends the position information to the message (step S35 of FIG. 11) and stores the message in memory 15. Message transmission unit 14 transmits the message that is held in memory 15 to position-designated message server 2 (step S36 in FIG. 11). Since the operations of position-designated message server 2 are the same as the operations in the first embodiment of the present invention that were shown in previously described FIG. 8, explanation of these operations is here omitted.

In this way, in the present embodiment, mobile terminal 1 that is the transmission origin can acquire the position of the location when transmitting a message that the user of mobile terminal 1 wishes to receive at that terminal and can automatically append this position information to the message that is transmitted, and thus can set the position at which subsequent reception of the message is desired to the position at which the message is transmitted. In this way, in a case in which mobile terminal 1 moves from position “a” in service area E1 of base station D1 to position “b” in service area E2 of base station D2 and then returns to position “a” in service area E1 as shown in FIG. 10, mobile terminal 1 can reliably receive the message that is addressed to its own terminal at the designated position “a.” Regarding the timing at which the position-designated message server begins requesting position acquisition, position-designated message server can be set to request position acquisition after receiving the message and after mobile terminal (A) has once gone outside service area E1. Alternatively, the position-designated message server can be set to request position acquisition after a predetermined prescribed time interval has elapsed after receiving the message.

### Third Embodiment

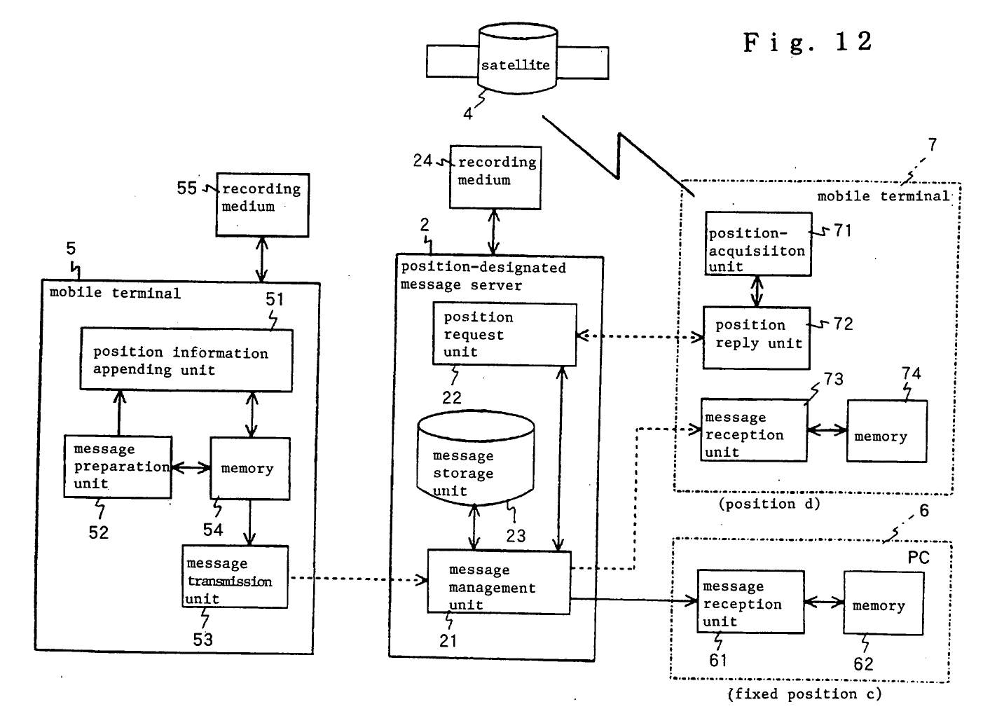

FIG. 12 is a block diagram showing the configuration of the message transmitting and receiving system according to the third embodiment of the present invention. In FIG. 12, even when there is only one destination address, the message transmitting and receiving system according to the third embodiment of the present invention has the capability of using position information to distribute a transmission message to one of a plurality of devices that is indicated by the same destination address.

When a message that designates destination address F is prepared in message preparation unit 52 in mobile terminal 5, a request for the transmission position is submitted from position information appending unit 51.

When the device of destination address F is PC (personal computer) 6 in fixed position c or mobile terminal 7 at position d, a message that designates destination address F can be distributed and transmitted to PC 6 or mobile terminal 7 by designating fixed position c or position d as the transmission position. In this case, it is assumed that PC 6 and mobile terminal 7 are set to transmit/receive e-mail and perform Web browsing at the same destination address F.

Accordingly, when fixed position c or position d is set as the transmission position, position information appending unit 51 appends this designated position information (fixed position c or position d) to the message and saves this message in memory 54. Message transmission unit 53 transmits the message that is held in memory 54 to position-designated message server 2.

Position-designated message server 2 extracts the destination address of the message and the position information that has been appended to the message, and then both stores the message and the position information in message storage unit 23 and acquires the position information of PC 6 or mobile terminal 7 that has been designated at destination address F. Since PC 6 is arranged at fixed position c in this case, the position information of this position can be obtained in advance, but for mobile terminal 7, a request for current position must be submitted from position request unit 22.

When the request for current position is sent in from position request unit 22, position reply unit 72 of mobile terminal 7 begins acquisition of position by means of position request unit 71 and transmits the position information that is obtained in position-acquisition unit 71 to position-designated message server 2.

Position-designated message server 2 compares the position information that was extracted from the message with the position information of PC 6 and the position information that was sent in from position reply unit 72 of mobile terminal 7, and when the position information that was extracted from the message matches with the position information of PC 6, delivers the message to PC 6 that is at fixed position c, whereby message reception unit 61 of PC 6 receives this message, saves the message in memory 62, and, for example, displays the message on a display unit (not shown).

Alternatively, when the position information that was extracted matches with the position information that was returned from position reply unit 72 of mobile terminal 7, position-designated message server 2 delivers the message to mobile terminal 7 at position d, whereby message reception unit 73 of mobile terminal 7 receives the message, stores the message in memory 74, and, for example, displays the message on a display unit (not shown).

In other words, PC 6 and mobile terminal 7 are connected to and receive e-mail from the same service provider (ISP: Internet Service Provider), and as a result, either providing position-designated message server 2 along with the same-mail server (not shown) in the service provider or providing position-designated message server 2 in the mail server enables position-designated message server 2 to operate such that PC 6 is allowed to acquire the message when the extracted position information matches with the position information of PC 6, and mobile terminal 7 is allowed to acquire the message when the extracted position information matches with the position information that is returned from position reply unit 72 of mobile terminal 7.

By means of the above-described operation, the present embodiment realizes the capability of delivering a message to one of a plurality of devices at different positions such as PC 6 at fixed position c and mobile terminal 7 at position d even when the message has only one destination address (only destination address F).

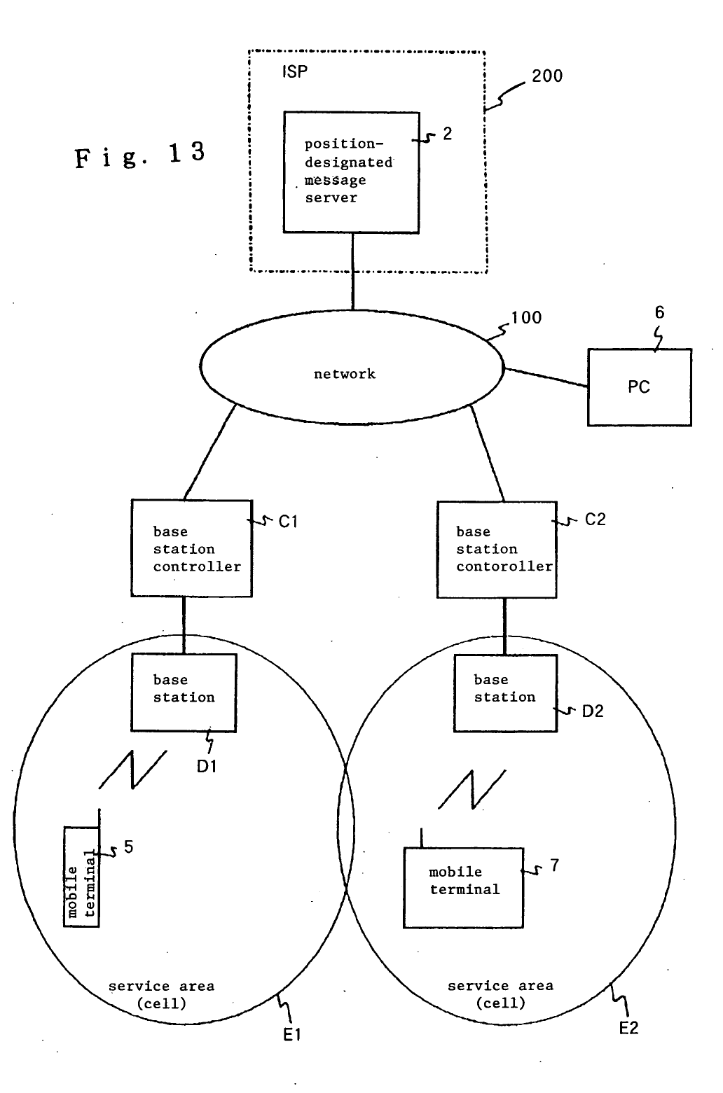

FIG. 13 is a block diagram showing an example of the actual system configuration of a message transmitting and receiving system according to the third embodiment of the present invention. In FIG. 13, mobile terminal 5 is in a state that allows communication in service area (cell) E1 that is controlled by base station D1 and mobile terminal 7 is able to communicate in service area (cell) E2 that is controlled by base station D2.

Position-designated message server 2 is arranged in service provider (ISP) 200 and is able to connect to mobile terminal 5 by way of network 100, base station controller C1, and base station D1, and is able to connect to mobile terminal 7 by way of network 100, base station controller C2, and base station D2. In addition, PC 6 is connected to network 100.

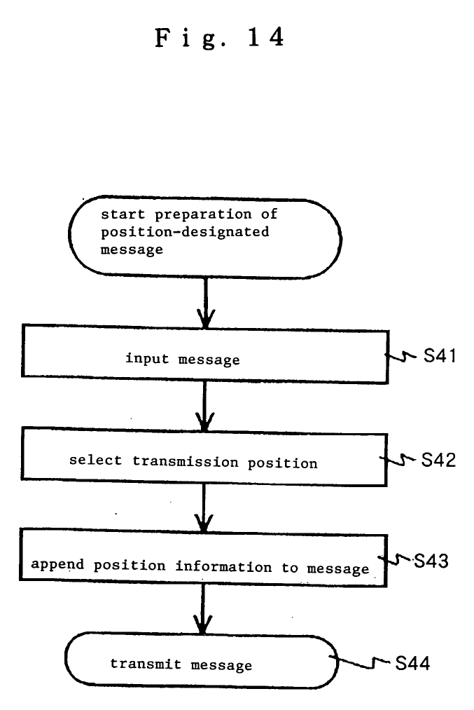

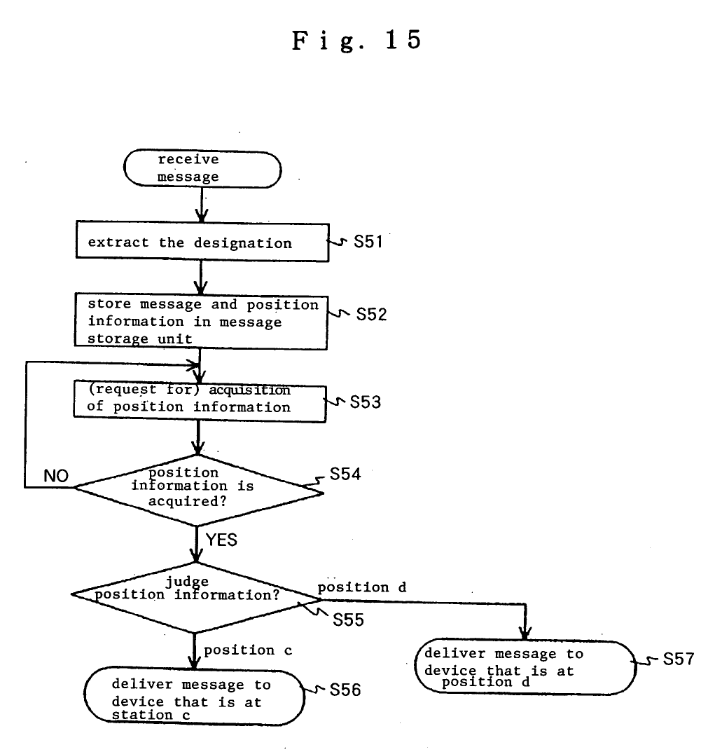

FIG. 14 is a flow chart showing the procedure for transmitting a position-designated message by means of the third embodiment of the present invention; and FIG. 15 is a flow chart showing the operation of position-designated message server 2 according to the third embodiment of the present invention. Referring to these FIGS. 12-15, explanation next regards the operations for preparing and transmitting a position-designated message, and in addition, the operations of position-designated message server 2 by means of the third embodiment of the present invention. The processes shown in FIG. 14 are realized by the execution of the programs of recording medium 55 by the computer of mobile terminal 5, and the processes shown in FIG. 15 are realized by the execution of the program of recording medium 24 by the computer of position-designated message server 2.

In mobile terminal 5, when a message that designates destination address F is prepared in message preparation unit 52 (step S41 of FIG. 14), a request for the position of transmission is submitted from position information appending unit 51. When position c or position d has been designated as the transmission position (step S42 in FIG. 14), position information appending unit 51 appends this position information to the message (step S43 in FIG. 14) and saves the message in memory 54. Message transmission unit 53 then transmits the message that is saved in memory 54 to position-designated message server 2 (step S44 in FIG. 14).

Message management unit 21 of position-designated message server 2, upon receiving the message to which position information has been appended from mobile terminal 5, extracts the destination address and position information from the message and both transfers the information to position request unit 22 (step S51 in FIG. 15) and stores the message in message storage unit 23 together with the position information (step S52 in FIG. 15).

Position-designated message server 2 obtains the position information of PC 6 or mobile terminal 7 that are designated by destination address F (step S53 of FIG. 15). Since PC 6 is arranged at fixed position c in this case, this position information can be obtained beforehand, but for mobile terminal 7, a request for current position must be submitted from position request unit 22. When the request for current position is sent in from position request unit 22, position reply unit 72 of mobile terminal 7 begins acquisition of position by means of position-acquisition unit 71 and transmits the position information that is obtained at position-acquisition unit 71 to position-designated message server 2.

Position-designated message server 2 compares the position information that was extracted from the message with the position information of PC 6 and the position information that has been send in from position reply unit 72 of mobile terminal 7, and when the position information that was extracted from the message matches with the position information of PC 6 (steps S54 and S55 in FIG. 15), delivers the message to PC 6 that is at fixed position c (step S56 in FIG. 15), whereby message reception unit 61 of PC 6 receives the message, saves the message in memory 62, and, for example, displays the message on a display unit (not shown).

Alternatively, when the position information that was extracted matches with the position information that was returned from position reply unit 72 of mobile terminal 7 (steps S54 and S55 in FIG. 15), position-designated message server 2 delivers the message to mobile terminal 7 that is at position d (step S57 in FIG. 15), whereby message reception unit 73 in mobile terminal 7 receives the message, saves the message in memory 74, and, for example, displays the message on a display unit (not shown).

If it is here assumed that PC 6 and mobile terminal 7 are set to transmit and receive e-mail and perform web browsing at the same destination address F, PC 6 and mobile terminal 7 are connected to and receive e-mail from the same service provider 200. As a result, either providing position-designated message server 2 along with the mail server in service provider 200 or providing position-designated message server 2 inside the mail server enables operation such that position-designated message server 2 allows PC 6 to obtain the message when the position information that was extracted matches with the position information of PC 6 and allows mobile terminal 7 to obtain the message when the position information that was extracted matches with the position information that was returned from position reply unit 72 of mobile terminal 7.

By means of the above-described operation, the present embodiment has the capability of distributing and delivering a message to one of a plurality of devices having different positions such as PC 6 at fixed position c and mobile terminal 7 at position d even when the message has only one destination address (only destination address F).

The present embodiment thus allows the transmission of a message that designates a position of a device that differs from the destination address at the time of transmitting the message, and a message can therefore be transmitted and directed among a plurality of devices even with only one destination address for the message that being transmitted.

### Fourth Embodiment

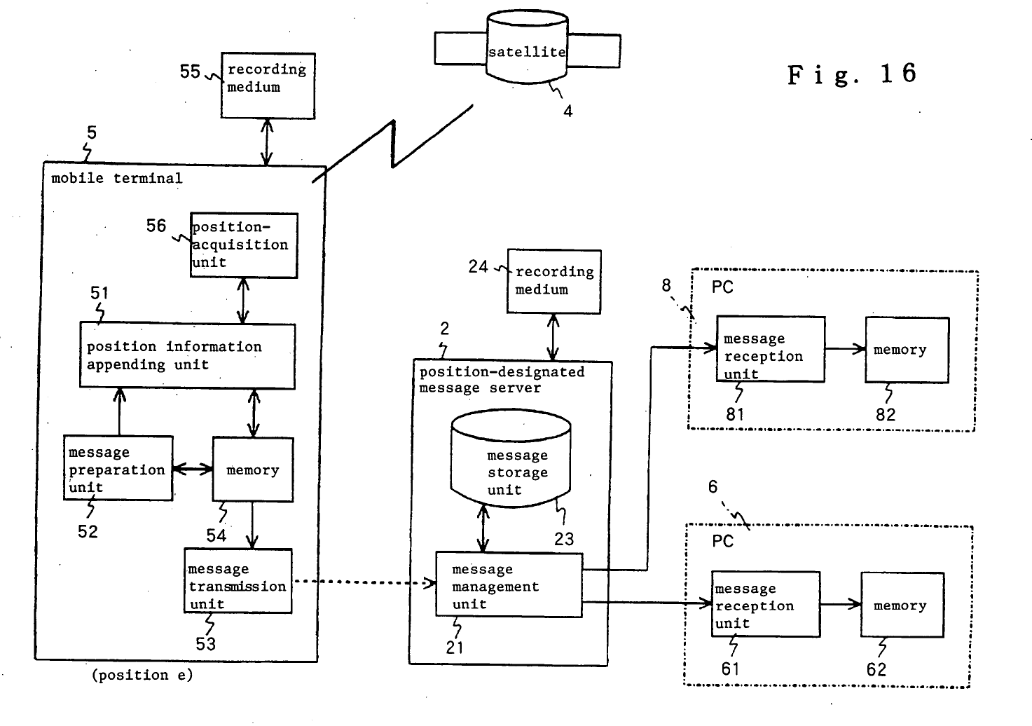

FIG. 16 is a block diagram showing the configuration of the message transmitting and receiving system according to the fourth embodiment of the present invention. In FIG. 16, the message transmitting and receiving system according to the fourth embodiment of the present invention, as in the above-described message transmitting and receiving system according to the third embodiment of the present invention, has the capability of using position information to enable a transmitted message to be directed to one among a plurality of devices even when using only one destination address.

In mobile terminal 5, acquisition of position first begins using position-acquisition unit 56, information of the current position of mobile terminal 5 is obtained, and when it is desired to direct the message that is being transmitted, message distribution information is produced for designating distribution of the transmitted message from the current position to either of PC 6 and PC 8 and transmitted to position-designated message server 2.

Message management unit 21 of position-designated message server 2, upon receiving the message distribution information from mobile terminal 5, creates a message distribution list based on this message distribution information, and records this message distribution list in a message management table in message storage unit 23. In this case, if there is no message management table that corresponds to the message distribution information from mobile terminal 5, message management unit 21 creates a new message management table, and, as described hereinabove, registers the message distribution list in this message management table.

When a message that designates destination address F is prepared in message preparation unit 52 in mobile terminal 5, position information appending unit 51 uses position-acquisition unit 56 to begin position acquisition to obtain information on the current position of mobile terminal 5. This position-acquisition unit 56 acquires the position information by methods similar to those of the previously described position-acquisition unit 11. Position information appending unit 51 appends the position information that is obtained by position-acquisition unit 56 to the message that was prepared in message preparation unit 52. The message to which this position information has been appended is then transmitted to position-designated message server 2 by message transmission unit 53 of mobile terminal 5.

Position-designated message server 2 extracts the position information that was appended to the message and the destination address of the message, refers to the message distribution list to determine the delivery destination of the message (one of PC 6 and PC 8), and delivers the message from mobile terminal 5 to PC 6 or PC 8 that was determined, whereby the message reception unit 61 or 81 of PC 6 or PC 8 receives the message. It is here assumed that PC 6 and PC 8 are set to transmit and receive e-mail and perform Web browsing by the same destination address F.

In other words, because PC 6 and PC 8 are connected to and receive e-mail from the same service provider, if position-designated message server 2 is provided along with the mail server in the service provider or is provided in the mail server, position-designated message server 2 may operate so as to permit acquisition of messages by PC 6 or PC 8 that has been determined based on a message distribution list.

According to the above-described operation, the present embodiment can realize the function of distributing and delivering a message to one of a plurality of devices having different positions, for example, to one of PC 6 and PC 8 that are each arranged at a different fixed position, even when there is only one destination address for the message (only destination address F). In addition, apart from the provision of PC 8 in place of mobile terminal 7, the actual example of the system configuration of the message transmitting and receiving system according to the fourth embodiment of the present invention is substantially equivalent to the actual example of the system configuration of the message transmitting and receiving system according to the third embodiment of the present invention that is shown in FIG. 13, and explanation of this specific example is therefore omitted.

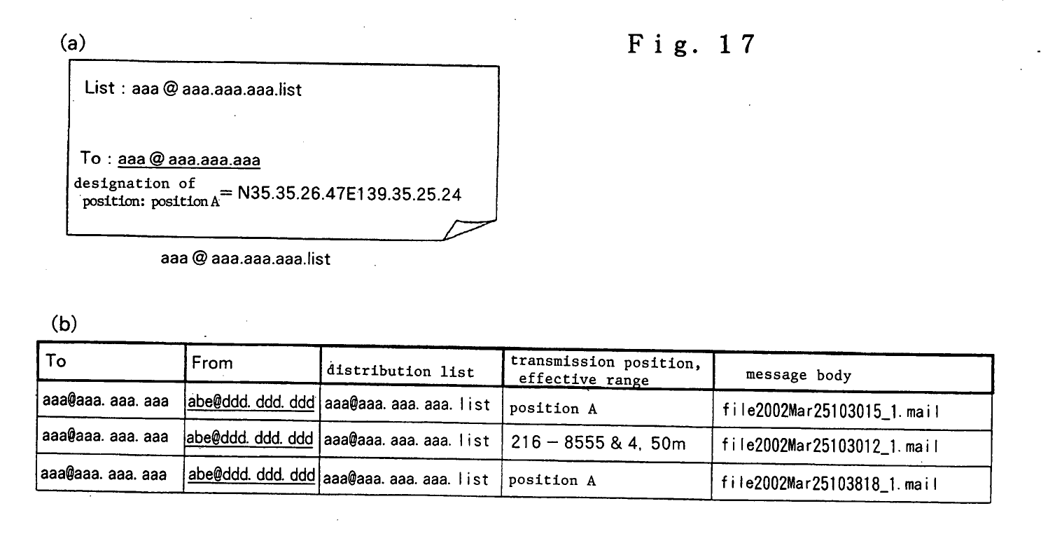

FIG. 17(a) shows an example of a message distribution list according to the fourth embodiment of the present invention, and FIG. 17(b) shows an example of a message management table according to the fourth embodiment of the present invention. In FIG. 17(a), the message distribution list is composed of: list name (List) “aaa@aaa.aaa.aaa.list”; destination address (To) “aaa@aaa.aaa.aaa”; and position setting information “position A=N35.35.26.47 E139.35.25.24”.

In FIG. 17(b), the message management table is composed of: the destination address (To) “aaa@aaa.aaa.aaa”; the transmission origin address (From) “abe@ddd.ddd.ddd”; the message distribution list name “aaa@aaa.aaa.aaa.list”; the transmission position and effective range “position A” and “216-8555&4, 50m”; and the message body. The file names “file2002Mar25103015_{—}1.mail”, “file2002Mar25103512_{—}1.mail”, and “file2002Mar25103818_{—}1.mail” that are shown in FIG. 7(c) are stored in the message body.

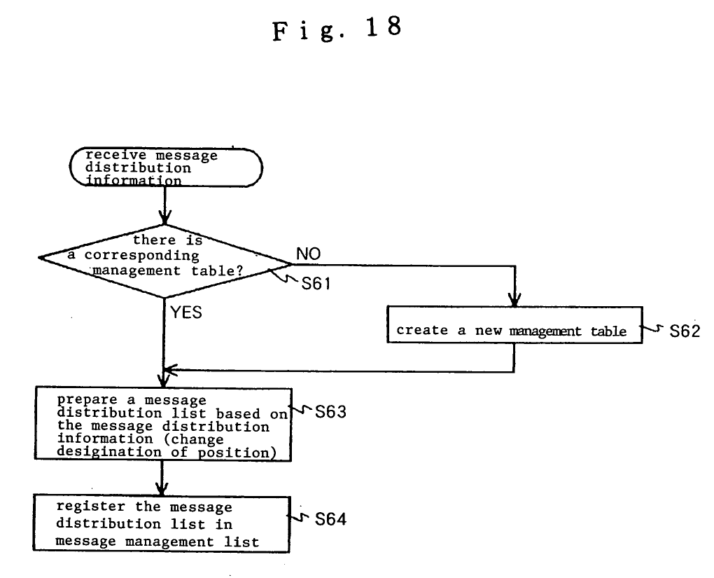

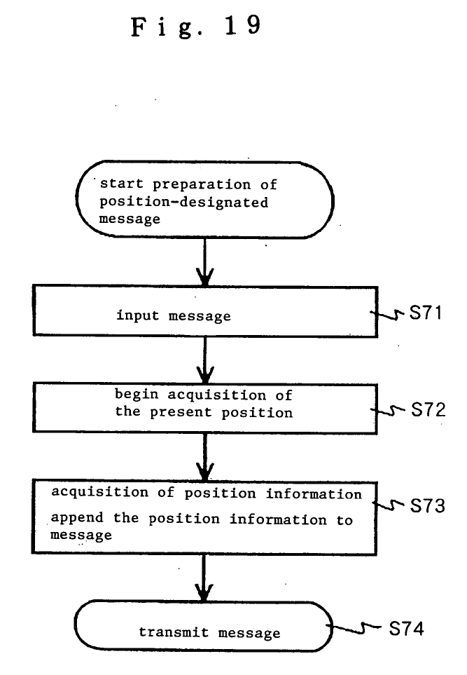

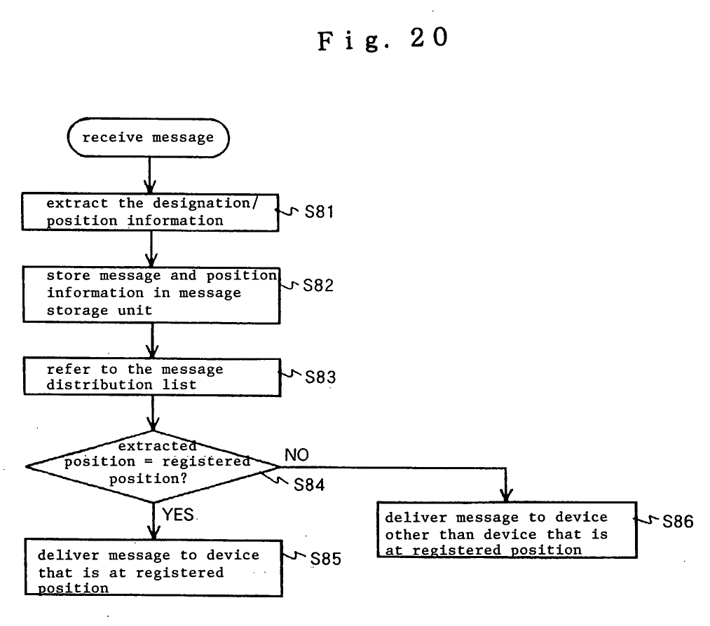

FIG. 18 is a flow chart showing the procedures for registering the message distribution list according to the fourth embodiment of the present invention, FIG. 19 is a flow chart showing the procedure for transmitting the position-designated message according to the fourth embodiment of the present invention, and FIG. 20 is a flow chart showing the operations of position-designated message server 2 according to the fourth embodiment of the present invention. Referring to these FIGS. 16-20, explanation next regards the procedure for registering the message distribution list, the operations for preparing and transmitting a position-designated message, and the operations of position-designated message server 2 according to the fourth embodiment of the present invention. The processes shown in FIG. 19 are realized by the execution of the programs of recording medium 55 by the computer of mobile terminal 5, and the processes shown in FIGS. 18 and 20 are realized by the execution of the programs of recording medium 24 by the computer of position-designated message server 2.

In mobile terminal 5, position-acquisition unit 56 is first used to begin acquisition of the position, information of the current position of mobile terminal 5 is acquired, and when the distribution of a transmitted message is desired, message distribution information is prepared for designating to which of PC 6 and PC 8 the message that is transmitted from the current position is to be distributed, and the message distribution information is then transmitted to position-designated message server 2.

Upon receiving the message distribution information from mobile terminal 5, message management unit 21 of position-designated message server 2, if there is a message management table that corresponds to that message distribution information (step S61 in FIG. 18), prepares a message distribution list based on the message distribution information (step S63 in FIG. 18), and registers the message distribution list in the message management table in message storage unit 23 (step S64 in FIG. 18).

If there is no message management table that corresponds to message distribution information from mobile terminal 5 (step S61 in FIG. 18), message management unit 21 creates a new message management table (step S62 in FIG. 18) and then registers this message distribution list in message management table as described hereinabove (steps S63 and S64 in FIG. 28).

In mobile terminal 5, when a message that designates destination address F is prepared in message preparation unit 52 (step S71 in FIG. 19), position information appending unit 51 uses position-acquisition unit 56 to begin acquisition of the position (step S72 in FIG. 19) and thus acquires information of the current position of mobile terminal 5. This position-acquisition unit 56 acquires the position information by the same method as the above-described position-acquisition unit 11. Position information appending unit 51 appends the position information that has been acquired by means of position-acquisition unit 56 to the message that was prepared in message preparation unit 52 (step S73 in FIG. 19). This message to which position information has been appended is saved in memory 54, and the message that is saved in memory 54 is transmitted from message transmission unit 53 to position-designated message server 2 (step S74 in FIG. 19).

Message management unit 21 of position-designated message server 2, upon receiving from mobile terminal 5 a message to which position information has been appended, extracts the destination address and position information from the message (step S81 in FIG. 20) and stores the message in message storage unit 23 together with the position information (step S82 in FIG. 20).

Message management unit 21 then refers to the message distribution list, determines the delivery destination of the message (either PC6 or PC 8) (step S83 in FIG. 20), and delivers the message from mobile terminal 5 to PC 6 or PC 8 that has been determined (steps S84 and S85 in FIG. 20), whereby the message reception unit 61 or 81 of PC 6 or PC 8 receives the message, stores the message in memory 62 or 82, and, for example, displays the message on a display unit (not shown). It is here assumed that PC 6 and PC 8 are both set to transmit and receive e-mail and browse the Web at the same destination address F.

In other words, PC 6 and PC 8 are connected to and receive e-mail from the same service provider, and as a result, by either providing position-designated message server 2 along with the mail server in the service provider or by providing position-designated message server 2 in the mail server, position-designated message server 2 can operate so as to permit either PC 6 or PC 8 that has been determined based on a message distribution list to obtain a message.

By means of the above-described operation, the present embodiment can realize the capability of distributing and delivering a message to one of a plurality of devices at different positions, for example, to one of PC 6 and PC 8 that are each arranged at different fixed positions, even when the message has only one destination address (only destination address F).

The present embodiment therefore enables transmission while designating a position at which a device is located other than the destination address at the time of transmitting the message, and as a result, enables the distribution and delivery of a message to a plurality of devices even when the transmitted message has only one destination address.

### Fifth Embodiment

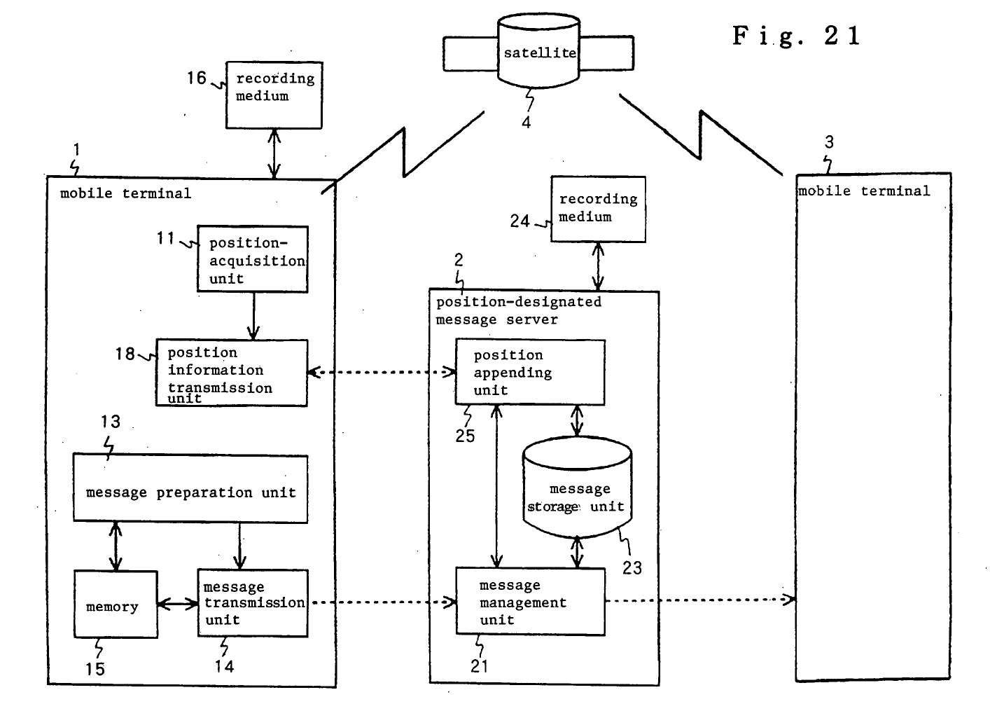

FIG. 21 is a block diagram showing the configuration of a message transmitting and receiving system according to the fifth embodiment of the present invention. In FIG. 21, the message transmitting and receiving system according to the fifth embodiment of the present invention is distinctive in that the addition of position information at the time a message is prepared at a terminal is not considered, the position of the terminal being acquired and the position information being appended after the server has received the message. In this case, mobile terminal 1 is made up from: position-acquisition unit 11, message preparation unit 13, message transmission unit 14, memory 15, recording medium 16, and position information transmission unit 18; and position-designated message server 2 is made up from: message management unit 21, message storage unit 23, and position-appending unit 25.

When a message is prepared by means of message preparation unit 13, mobile terminal 1 saves the prepared message in memory 15 and transmits the message from message transmission unit 14 to position-designated message server 2. Upon receiving the message from mobile terminal 1, message management unit 21 of position-designated message server 2 stores the message in message storage unit 23 and, if there is a designation to append position, reports this message to position-appending unit 25. When the message is reported, position-appending unit 25 requests mobile terminal 1 for its location.

Upon receiving the request for its location, position information transmission unit 18 of mobile terminal 1 activates position-acquisition unit 11 and acquires the location of its own terminal. When position-acquisition unit 11 has completed the acquisition of the position of its own terminal, this position information is reported to position information transmission unit 18, and position information transmission unit 18 transmits this position information to position-appending unit 25 of position-designated message server 2. The operation of transmitting position information by position information transmission unit 18 is similar to the above-described operation of position information transmission unit 32 of mobile terminal 3.

Position-designated message server 2, upon receiving the position information, adds this position information to the previously received message and saves in message storage unit 23. Position-designated message server 2 submits an inquiry for the area in which the destination mobile terminal 3 is located to the base station controller, and when mobile terminal 3 arrives in the service area of the base station, which is the area that is indicated by the above-described position information, position-designated message server 2 transmits the message that has been saved in message storage unit 23 to mobile terminal 3. Mobile terminal 3 is thus able to receive a message in which a position is designated.

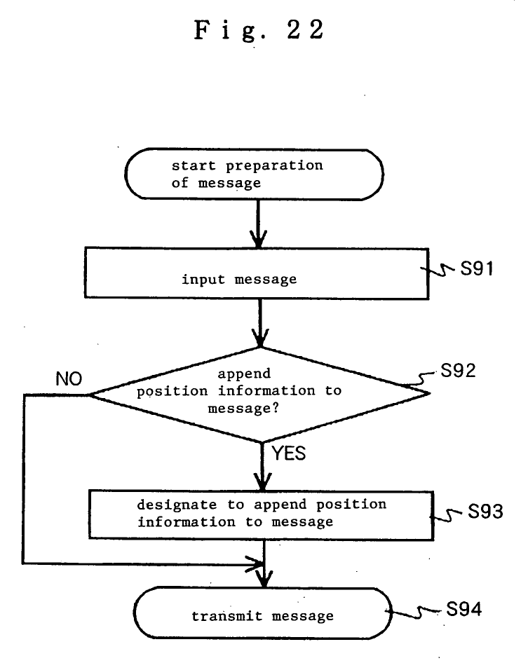

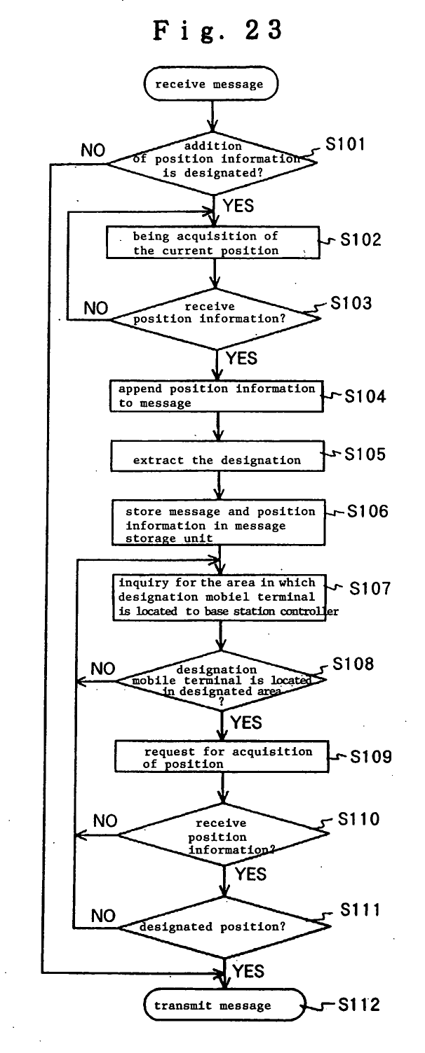

FIG. 22 is a flow chart showing the procedure for transmitting a message that designates a position according to the fifth embodiment of the present invention, and FIG. 23 is a flow chart showing the operation of position-designated message server 2 according to the fifth embodiment of the present invention. Referring to these FIGS. 21-23, explanation next regards the operations of preparing and transmitting a position-designated message and the operations of position-designated message server 2 according to the fifth embodiment of the present invention.

The processes shown in FIG. 23 are realized by the execution of the programs of recording medium 24 by the computer of position-designated message server 2. In addition, the actual system configuration of the message transmitting and receiving system according to the fifth embodiment of the present invention is substantially equivalent to the example of the actual system configuration of the message transmitting and receiving system according to the first embodiment of the present invention that is shown in FIG. 3, and explanation of this configuration is therefore here omitted.

When a message is prepared by means of message preparation unit 13 (step S91 in FIG. 22), if position information is to be appended to this message (step S92 in FIG. 22), mobile terminal 1 designates to append position information in the message (step S93 in FIG. 22), and transmits the message from message transmission unit 14 to position-designated message server 2 (step S94 in FIG. 22).

Upon receiving the message from mobile terminal 1, message management unit 21 of position-designated message server 2 reports this message to position-appending unit 25 if there is a designation to append position information to the message (step S101 in FIG. 23). When the message is reported, position-appending unit 25 submits a request to mobile terminal 1 for its position (step S102 in FIG. 23).

Position information transmission unit 18 of mobile terminal 1, having received the request for its position, activates position-acquisition unit 11 and acquires the position of its own terminal. Position-acquisition unit 11, upon completing the acquisition of the position of its terminal, reports this position information to position information transmission unit 18, and position information transmission unit 18 transmits this position information to position-appending unit 25 of position-designated message server 2.

When position-designated message server 2 receives the position information (step S103 in FIG. 23), it appends this position information to the previously received message (step S104 in FIG. 23) and stores the message in message storage unit 23 (step S106 in FIG. 23). Message management unit 21 of position-designated message server 2 extracts the destination address from this message (step S105 in FIG. 23), monitors the position at which the destination address mobile terminal 3 is located and submits inquiries to base station controller for the area in which destination mobile terminal 3 is located (step S107 in FIG. 23), and when mobile terminal 3 arrives in the service area of the base station that is the area included in the above-described position information (step S108 in FIG. 23), requests the position at which mobile terminal 3 is located (step S109 in FIG. 23).

When mobile terminal 3 has come to the designated position (steps S110 and S111 in FIG. 23), position-designated message server 2 transmits the message that is stored in message storage unit 23 to mobile terminal 3 (step S112 in FIG. 23), whereby mobile terminal 3 is able to receive a message in which a position is designated.

Thus, in the present embodiment, a server that has received a message requests the position of the terminal that is the transmission origin and appends this position information to the message, whereby, when the position at which the message is to be received is designated to the current position, the server can make settings without requiring the terminal to append the position information to the message and then transmit.

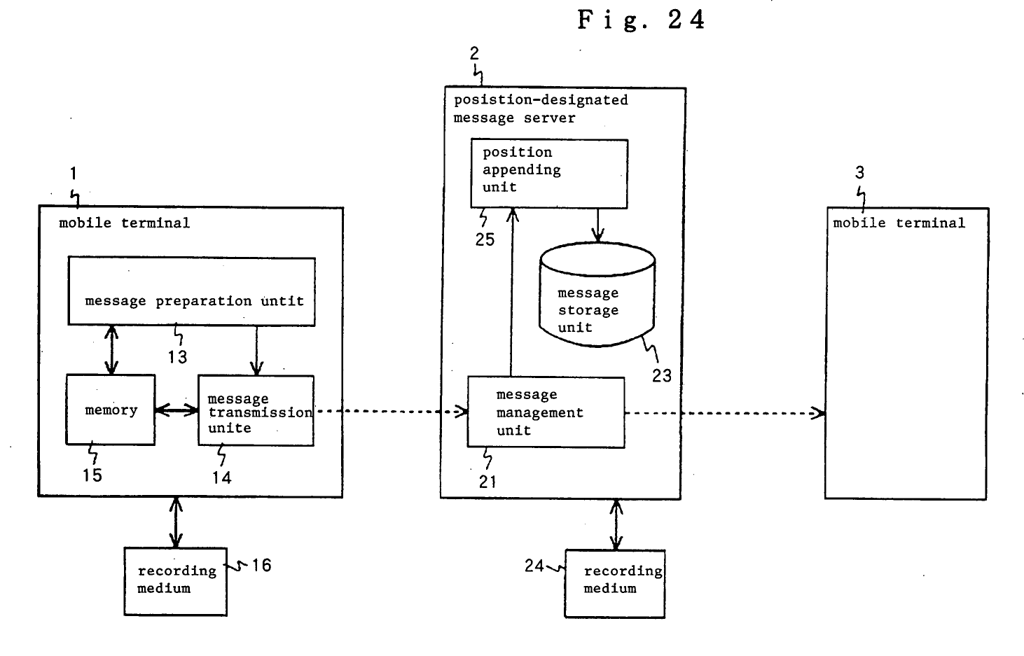

FIG. 24 is a block diagram showing the configuration of a message transmitting and receiving system according to the sixth embodiment of the present invention. In FIG. 24, the message transmitting and receiving system according to the sixth embodiment of the present invention can realize the same functions as the above-described fifth embodiment of the present invention even though the mobile terminal does not have the capability to acquire its own position.

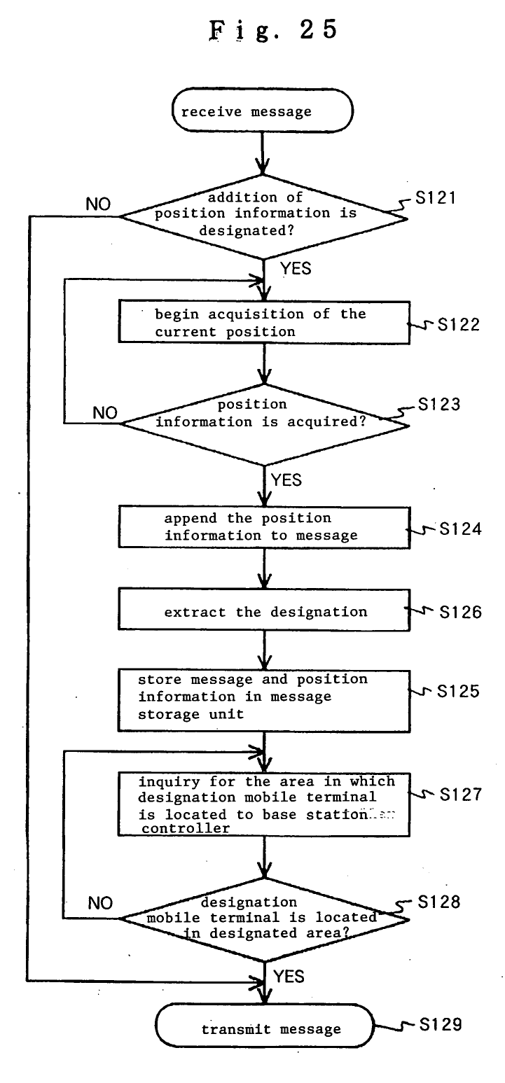

FIG. 25 is a flow chart showing the operations of position-designated message server 2 according to the sixth embodiment of the present invention. Referring to FIGS. 24 and 25, explanation next regards the operations of position-designated message server 2 according to the sixth embodiment of the present invention. The processes shown in FIG. 25 are realized by the execution of the programs of recording medium 24 by the computer of position-designated message server 2. In addition, the actual system configuration of the message transmitting and receiving system according to the sixth embodiment of the present invention is substantially equivalent to the actual system configuration of the message transmitting and receiving system according to the first embodiment of the present invention shown in FIG. 3, and explanation of this configuration is therefore here omitted.

The operations for the preparation and transmission of a position-designated message by mobile terminal 1 are similar to the operations for the preparation and transmission of a position-designated message according to the fifth embodiment of the present invention that is shown in the above-described FIG. 22. In other words, mobile terminal 1 prepares a transmission message by means of message preparation unit 13, and if position information is to be appended to this message, designates the addition of position information in this message and transmits this message to position-designated message server 2 by means of message transmission unit 14.

Message management unit 21 of position-designated message server 2 receives this message from mobile terminal 1, and if the addition of position information to this message is designated (step S121 in FIG. 25), reports to position-appending unit 25. Position-appending unit 25 refers to the service area of the base station in which mobile terminal 1 was located at the time the message was transmitted, takes information (such as information on the latitude and longitude of the base station and its effective range) that specifies the service area of this base station as the position information (steps S122 and S123 in FIG. 25), appends this position information to the message (step S124 in FIG. 25), extracts the destination address from the message (step S126 in FIG. 25), and stores the message and position information in message storage unit 23 (step S125 in FIG. 25).

Position-designated message server 2 submits an inquiry for the area in which destination mobile terminal 3 is located to the base station controller and periodically checks the service area of the base station in which mobile terminal 3 is located (steps S127 and S128 in FIG. 25). When position-designated message server 2 confirms that mobile terminal 3 is located in the same service area as mobile terminal 1 when mobile terminal 1 sent the message (step S128 in FIG. 25), position-designated message server 2 fetches the relevant message from message storage unit 23 and transmits the message to mobile terminal 3 (step S129 in FIG. 25).

The present embodiment thus enables a message transmitting and receiving system structure in which a position-designated message can be easily transmitted and received without requiring that mobile terminals have the capability to acquire position. In this way, in the present embodiment, a server that has received a message requests the position of the terminal that is the transmission origin and appends this position information to the message, and as a result, when the position at which the message is to be received is designated to the current position, the settings can be made without requiring a terminal to append the position information to the message and then transmit.

In devices such as portable telephones and PDA (Personal Digital Assistants), improvements in functionality have been sought in recent years to allow, for example, transmitting and receiving e-mail and Web browsing. At the same time, the necessity for ever smaller and lighter equipment terminals has continued. However, satisfying the need for smaller and lighter equipment terminals also places limitations on the memory capacity that can be incorporated in these equipment terminals.

Given these limitations, appending position information to a message as in the present invention tends to reduce the number of messages that can be stored in the above-described equipment terminals. In the present invention, however, these equipment terminals need only receive the messages, and even under the above-described limitations, it is possible to set the position at which a message is to be received to the position at which the message was transmitted, or to designate the position at which the message is to be received in the message that is transmitted.

When seeking the position of a terminal that is to receive the above-described message, the operation for acquiring the exact position can be carried out after the terminal has entered the area of the base station (relay device) that corresponds to the designated position, thus eliminating the need for increasing the load imposed on the control system of the terminal itself. Further, taking the area of the base station (relay device) as the designated position largely eliminates the load that is placed on the terminal. In addition, the designated position can also designate the area of a base station (relay device) as in this case, or can designate a pinpoint or the area that is within a certain number of meters from a pinpoint.

1. A terminal device comprising:
means for receiving as input a destination of a message that is to be transmitted and a position at which the message is be received; and
means for appending to said message position information that indicates said position that has been received as input.

2. A terminal device according to claim 1, further comprising position-acquisition means for acquiring the current position information;
wherein said appending means appends to said message position information that has been acquired by said position-acquisition means as position information of the position at which the message is to be received.

3. A terminal device comprising:
position-acquisition means for receiving a position request from a server device and then acquiring a position; and
a position information transmission means for transmitting position information that has been acquired by said position-acquisition means to said server device.

4. A server device for delivering a message that has been transmitted from a terminal device that is a transmission origin to a terminal device that is the transmission destination; said server device comprising:
message storage means for, upon receiving a message that has been transmitted from a terminal device that is a transmission origin, storing the message that has been received;
position request means for extracting a destination address and position information from a message that has been stored in said message storage means and submitting a position request to the terminal device that is the transmission destination that is indicated by the destination address; and
message management means for transmitting the message to said terminal device that is the transmission destination when position information that has been appended to said message matches with position information from said terminal device that is the transmission destination that has been transmitted in response to said position request.

5. A server device for delivering a message that has been transmitted from a terminal device that is a transmission origin to a terminal device that is a transmission destination, the server device comprising:
message storage means for storing messages;
position request means for, upon receiving a message that has been transmitted from a terminal device that is a transmission origin, submitting a position request to the terminal device that is the transmission origin of the message that has been received, and further, extracting a destination address and position information from a message that is stored in said message storage means and submitting a position request to the terminal device that is the transmission destination of the destination address;
appending means for appending position information of said terminal device that is the transmission origin that has been transmitted in response to a position request to said terminal device of the transmission origin to said message as position information of the position at which the message is to be received and storing in said message storage means; and
message management means for transmitting the message to said terminal device that is the transmission destination when position information of said terminal device that is the transmission destination and that has been transmitted in response to a position request to said terminal device that is the transmission destination matches with position information that has been appended to said message.

6. A message transmitting and receiving system for delivering a message that has been transmitted from a terminal device that is a transmission origin to a terminal device that is a transmission destination, said message transmitting and receiving system comprising:
a terminal device that is the transmission origin that includes:
means for receiving as input the destination of a message and the position at which the message is to be received, and appending means for appending to said message position information that indicates said position that has been received as input;
a server device that includes:
message storage means for, upon receiving a message that has been transmitted from said terminal device that is the transmission origin, storing the message that has been received;
position request means for extracting a destination address and position information from a message that has been stored in said message storage means and submitting a position request to a terminal device that is the transmission destination that is indicated by said destination address; and
message management means for transmitting said message to said terminal device that is the transmission destination when position information that has been appended to said message matches with position information from said terminal device that is the transmission destination that has been transmitted in response to said request for position; and
a terminal device that is the transmission destination that includes:
first position-acquisition means for receiving a position request from said server device and acquiring position; and
position information transmission means for transmitting position information that has been acquired by said first position-acquisition means to said server device.

7. A message transmitting and receiving system according to claim 6, wherein:
said terminal device that is the transmission origin further includes second position-acquisition means for acquiring the current position information;
said appending means appends position information that has been acquired by said second position-acquisition means to said message as position information of a position at which the message is to be received.

8. A message transmitting and receiving system for transmitting a message that has been transmitted from a terminal device that is a transmission origin to a terminal device that is a transmission destination, said message transmitting and receiving system comprising:
a terminal device that is the transmission origin that includes:
first position-acquisition means for receiving a position request from said server device and acquiring position; and
position information transmission means for transmitting position information that has been acquired by said first position-acquisition means to said server device;
a server device that includes:
message storage means for storing messages;
position request means for, upon receiving a message that has been transmitted from a transmission origin terminal device, submitting a position request to the terminal device that is the transmission origin of the message that has been received, and further, extracting the destination address and position information from a message that has been stored in said message storage means and submitting a position request to the transmission destination terminal device of the destination address;
appending means for appending to said message position information of said terminal device that is the transmission origin that has been transmitted in response to the position request to said terminal device that is the transmission origin as position information of the position at which the message is to be received and storing the message in said message storage means; and
message management means for transmitting the message to said terminal device that is the transmission destination when position information that has been appended to said message matches with position information of said terminal device that is the transmission destination that has been transmitted in response to the position request to said terminal device that is the transmission destination; and
a terminal device that is the transmission destination that includes:
second position-acquisition means for accepting a position request from said server device and then acquiring position; and
position information transmission means for transmitting position information that has been acquired by said second position-acquisition means to said server device.

9. A message transmitting and receiving method, comprising steps wherein:
in a terminal device that is a transmission origin, a destination to which a message is to be transmitted and a position at which the message is to be received are received as input; and
said terminal device that is the transmission origin appends position information that indicates said position that has been received as input to said message and then transmits said message.

10. A message transmitting and receiving method according to claim 9, further comprising a step of:
acquiring the current position information of said terminal device that is the transmission origin
wherein, in said step of appending position information to said message, said acquired position information is appended to said transmission message as position information of the position at which the transmission message is to be received.

11. A message transmitting and receiving method, comprising steps wherein:
a terminal device that is a transmission destination accepts a position request from a server device and acquires position; and
said terminal device that is the transmission destination transmits said position information that has been acquired to said server device.

12. A message transmitting and receiving method for delivering a message that has been transmitted from a terminal device that is a transmission origin to a terminal device that is a transmission destination, said message transmitting and receiving method comprising steps of:
upon receiving a message that is transmitted from a terminal device that is a transmission origin, storing the message that has been received;
extracting a destination address and position information from a message that has been stored and submitting a position request to a transmission destination terminal device of the destination address;
transmitting the transmission message to said transmission destination terminal device when position information that has been appended to said transmission message matches with position information from said transmission destination terminal device that has been transmitted in response to said position request.

13. A message transmitting and receiving method for delivering a message that has been transmitted from a terminal device that is a transmission origin to a terminal device that is a transmission destination, said message transmitting and receiving method comprising steps of:
upon receiving a message that is transmitted from a terminal device that is a transmission origin, submitting a position request to the terminal device that is the transmission origin that has transmitted in the message that was received;
appending position information of said terminal device that is the transmission origin that has been transmitted in response to the position request to said terminal device that is the transmission origin to said transmission message as position information of the position at which said transmission message is to be received and storing said transmission message;
extracting a destination address and position information from a message that has been stored and submitting a position request to the transmission destination terminal device of the destination address; and
transmitting the transmission message to said transmission destination terminal device when position information that has been appended to said transmission message matches with position information from said transmission destination terminal device that has been transmitted in response to said position request.

14. A message transmitting and receiving method for delivering a message that has been transmitted from a terminal device to a terminal device that is a transmission destination, said message transmitting and receiving method comprising steps wherein:
the terminal device that is the transmission origin receives as input a destination of a transmission message and a position at which the transmission message is to be received;
the terminal device that is the transmission origin appends position information that indicates the position that has been received as input to said transmission message;
a server device, upon receiving a message that is transmitted from the terminal device that is the transmission origin, stores the message that has been received;
said server device extracts a destination address and position information from the message that has been stored and submits a position request to the transmission destination terminal device of the destination address;
the terminal device that is the transmission destination receives the position request from said server device and acquires position;
said terminal device that is the transmission destination transmits the acquired position information to said server device; and
said server device transmits the transmission message to said transmission destination terminal device when position information that is appended to said transmission message matches with position information from said transmission destination terminal device that has been transmitted in response to said position request.

15. A message transmitting and receiving method according to claim 14, further comprising a step wherein:
said terminal device that is the transmission origin acquires current position information;
wherein, in the step of appending position information to said message, said terminal device that is the transmission origin appends said position information that has been acquired to said message as position information of the position at which the message is to be received.

16. A message transmitting and receiving method for delivering a message that has been transmitted from a terminal device to a terminal device that is a transmission destination, said message transmitting and receiving method comprising steps wherein:
a server device, upon receiving a message that has been transmitted from a terminal device that is the transmission origin, submits a position request to the terminal device that is the transmission origin that has transmitted the message that has been received;
said terminal device that is the transmission origin receives the position request from said server device and acquires its position;
said server device appends the position information of said terminal device that is the transmission origin that has been transmitted in response to the position request to said terminal device that is the transmission origin to said transmission message as position information of the position at which the message is to be received and stores the message;
said server device extracts a destination address and position information from the message that has been stored and submits a position request to the transmission destination terminal device of the destination address;
the terminal device that is the transmission destination receives the position request from the server device and acquires position;
said terminal device that is the transmission destination transmits said position information that has been acquired to said server device;
said server device transmits the transmission message to said transmission destination terminal device when position information that is appended to said transmission message matches with position information from said transmission destination terminal device that has been transmitted in response to said position request.

17. A program for causing a computer to execute processes wherein:
in a terminal device that is a transmission origin, a destination to which a message is to be transmitted and a position at which the message is to be received are received as input; and
said terminal device that is the transmission origin appends position information that indicates said position that has been received as input to said message and then transmits said message.

18. A program according to claim 9 for causing a computer to execute further processes of:
acquiring current position information of said terminal device that is the transmission origin
appending said position information that has been acquired to said transmission message as position information of the position at which the transmission message is to be received.

19. A program for causing a computer to execute processes wherein:
a terminal device that is the transmission destination receives a position request from a server device and acquires position; and
said terminal device that is the transmission destination transmits said position information that has been acquired to said server device.

20. A program for causing a computer to execute a message transmitting and receiving method for delivering a message that has been transmitted from a terminal device that is a transmission origin to a terminal device that is a transmission destination, said program causing a computer to execute processes of:
upon receiving a message that has been transmitted from a terminal device that is a transmission origin, storing the message that has been received;
extracting a destination address and position information from the message that has been stored and submitting a position request to the transmission destination terminal device of the destination address; and
transmitting the transmission message to said transmission destination terminal device when position information that is appended to said transmission message matches with position information from said transmission destination terminal device that has been transmitted in response to said position request.

21. A program for causing a computer to execute a message transmitting and receiving method for delivering a message that has been transmitted from a terminal device that is a transmission origin to a terminal device that is a transmission destination, said program causing a computer to execute processes of:
upon receiving a message that is transmitted from a terminal device that is a transmission origin, submitting a position request to the terminal device that is the transmission origin that has transmitted in the message that was received;
appending position information of said terminal device that is the transmission origin that has been transmitted in response to the position request to said terminal device that is the transmission origin to said transmission message as position information of the position at which said transmission message is to be received and storing said transmission message;
extracting a destination address and position information from a message that has been stored and submitting a position request to the transmission destination terminal device of the destination address; and
transmitting said transmission message to said transmission destination terminal device when position information that has been appended to said transmission message matches with position information from said transmission destination terminal device that has been transmitted in response to said position request.

22. A program for causing a computer to execute a message transmitting and receiving method for delivering a message that has been transmitted from a terminal device to a terminal device that is a transmission destination, said program causing a computer to execute processes wherein:
a terminal device that is the transmission origin receives as input a destination of a transmission message and a position at which said transmission message is to be received;
the terminal device that is the transmission origin appends position information that indicates the position that has been received as input to said transmission message;
a server device, upon receiving a message that is transmitted from the terminal device that is the transmission origin, stores the message that has been received;
said server device extracts a destination address and position information from the message that has been stored and submits a position request to the transmission destination terminal device of the destination address;
the terminal device that is the transmission destination receives the position request from said server device and acquires position;
said terminal device that is the transmission destination transmits the acquired position information to said server device; and
said server device transmits the transmission message to said transmission destination terminal device when position information that is appended to said transmission message matches with position information from said transmission destination terminal device that has been transmitted in response to said position request.

23. A program according to claim 22 for causing a computer to execute further processes wherein:
said terminal device that is the transmission origin acquires current position information;
said terminal device that is the transmission origin appends said position information that has been acquired to said message as position information of the position at which said message is to be received.

24. A program for causing a computer to execute a message transmitting and receiving method for delivering a message that has been transmitted from a terminal device to a terminal device that is a transmission destination, said program causing a computer to execute processes wherein:
a server device, upon receiving a message that has been transmitted from a terminal device that is the transmission origin, submits a position request to the terminal device that is the transmission origin that has transmitted the message that has been received;
said terminal device that is the transmission origin receives the position request from said server device and acquires position;
said server device appends the position information of said terminal device that is the transmission origin that has been transmitted in response to the position request to said terminal device that is the transmission origin to said transmission message as position information of the position at which said transmission message is to be received and stores the message;
said server device extracts a destination address and position information from the message that has been stored and submits a position request to the transmission destination terminal device of the destination address;
the terminal device that is the transmission destination receives the position request from said server device and acquires position;
said terminal device that is the transmission destination transmits said position information that has been acquired to said server device;
said server device transmits said transmission message to said transmission destination terminal device when position information that is appended to said transmission message matches with position information from said transmission destination terminal device that has been transmitted in response to said position request.
